(19) United States
(12) Patent Application Publication
(10) Pub. No.: US 2025/0385246 A1
(43) Pub. Date: Dec. 18, 2025

(54) ANODES FOR LITHIUM-BASED ENERGY STORAGE DEVICES

(71) Applicant: Graphenix Development, Inc., Williamsville, NY (US)

(72) Inventors: Robert G. Anstey, Williamsville, NY (US); John C. Brewer, Williamsville, NY (US)

(73) Assignee: Graphenix Development, Inc., Williamsville, NY (US)

(21) Appl. No.: 18/877,736

(22) PCT Filed: Jun. 20, 2023
(86) PCT No.: PCT/US2023/025773

§ 371 Date: Dec. 20, 2024

Related U.S. Application Data
(60) Provisional application No. 63/353,897, filed on Jun. 21, 2022.

(51) Int. Cl. H01M 4/134; H01M 4/02; H01M 4/66; H01M 4/70; H01M 10/0525

(52) U.S. Cl. CPC H01M 4/134; H01M 4/661; H01M 4/667; H01M 4/70; H01M 10/0525; H01M 2004/027

(57) ABSTRACT

An anode for an energy storage device includes an electrically conductive layer and a surface layer disposed over the electrically conductive layer. The current collector surface may be characterized by a plurality of grooves. A lithium storage layer overlays the surface layer. The lithium storage layer is characterized by a first average thickness and may include at least 40 atomic % silicon, germanium, or a combination thereof. In at least one lateral dimension, the grooves may be spaced apart by an average spacing distance that is 0.4 to 50 times the first average thickness.

### CROSS-REFERENCES TO RELATED APPLICATION

This application claims the benefit of priority of U.S. Provisional Application No. 63/353,897 filed Jun. 21, 2022, the entire contents of which is incorporated by reference in its entirety for all purposes.

### TECHNICAL FIELD

The present disclosure relates to lithium-ion batteries and related energy storage devices.

### BACKGROUND

Silicon has been proposed for lithium-ion batteries to replace the conventional carbon-based anodes, which have a storage capacity that is limited to ˜370 mAh/g. Silicon readily alloys with lithium and has a much higher theoretical storage capacity (˜3600 to 4200 mAh/g at room temperature) than carbon anodes. However, insertion and extraction of lithium into the silicon matrix causes significant volume expansion (>300%) and contraction. This can result in rapid pulverization of the silicon into small particles and electrical disconnection from the current collector.

The industry has recently turned its attention to nano- or micro-structured silicon to reduce the pulverization problem, i.e., silicon in the form of spaced apart nano- or micro-wires, tubes, pillars, particles, and the like. The theory is that making the structures nano-sized avoids crack propagation and spacing them apart allows more room for volume expansion, thereby enabling the silicon to absorb lithium with reduced stresses and improved stability compared to, for example, macroscopic layers of bulk silicon.

Despite research into various approaches, batteries based primarily on silicon have yet to make a large market impact due to unresolved problems.

### SUMMARY

There remains a desire for anodes for lithium-based energy storage devices such as Li-ion batteries that are easy to manufacture, robust to handling, high in storage capacity, amenable to fast charging, for example, at least 1C, and have good cycle life.

In accordance with an embodiment of this disclosure, an anode for an energy storage device includes an electrically conductive layer and a surface layer disposed over the electrically conductive layer. The current collector surface may be characterized by a plurality of grooves. A lithium storage layer overlays the surface layer. The lithium storage layer is characterized by a first average thickness and may include at least 40 atomic % silicon, germanium, or a combination thereof. In at least one lateral dimension, the grooves may be spaced apart by an average spacing distance that is 0.4 to 50 times the first average thickness. The lithium storage layer may be a continuous porous lithium storage layer. The energy storage device may be a lithium-ion battery.

The present disclosure provides anodes for energy storage devices that may have one or more of at least the following advantages relative to conventional anodes: improved stability at aggressive≥1C charging and/or discharging rates; higher overall areal storage capacity; higher storage capacity per gram of lithium storage material (e.g., silicon); higher volumetric density batteries; higher gravimetric density batteries; improved physical durability; simplified manufacturing process; more reproducible manufacturing process; reduced environmental impact manufacturing process; or reduced dimensional changes during operation.

### BRIEF DESCRIPTION OF DRAWINGS

FIG. 1A is a cross-sectional view of a non-limiting example of an anode according to some embodiments.

FIG. 1B is a cross-sectional view of a prior art anode.

FIG. 2A is a plan view of a non-limiting example of an electrically conductive layer according to some embodiments.

FIG. 2B is a cross-sectional view of the electrically conductive layer of FIG. 2A.

FIG. 2C is a cross-sectional view of a non-limiting example of a current collector according to some embodiments.

FIG. 2D is a cross-sectional view of a non-limiting example of forming an anode according to some embodiments.

FIG. 2E is a cross-sectional view of a non-limiting example of an anode after electrochemical cycling according to some embodiments.

FIG. 3A is a plan view of a non-limiting example of a current collector according to some embodiments.

FIG. 3B is a cross-sectional view of the current collector from FIG. 3A.

FIGS. 4A-4G are cross-sectional views of non-limiting examples of grooves according to some embodiments.

FIGS. 5A-51 are plan views of non-limiting examples of current collectors according to some embodiments.

FIGS. 6A-6D are cross-sectional views of non-limiting examples of current collectors according to some embodiments.

FIG. 7 is a cross-sectional view of a non-limiting example of an anode according to some embodiments.

FIGS. 8A-8C are cross sectional views of some non-limiting examples of current collectors according to some embodiments.

### DETAILED DESCRIPTION

It is to be understood that the drawings are for purposes of illustrating the concepts of the disclosure and may not be to scale. Terms like “overlaying”, “over” or the like include, but do not necessarily require, direct contact (unless such direct contact is noted or clearly required for functionality). Additional details of certain embodiments of the present application may be found in U.S. Pat. Nos. 10,910,653, 11,024,842, U.S. Application Publication No. 2021/0050584, U.S. Application Publication No. 2021/0057733, U.S. Application Publication No. 2021/0057757, U.S. Application Publication No. 2021/0057755, U.S. Application Publication No. 2021/0066702, PCT International Publication Number WO2022/005999, PCT Application No. PCT/US2021/064018, PCT Application No. PCT/US2022/053321, and PCT Application No. PCT/US2023/024254, the entire contents of which are incorporated herein by reference for all uses.

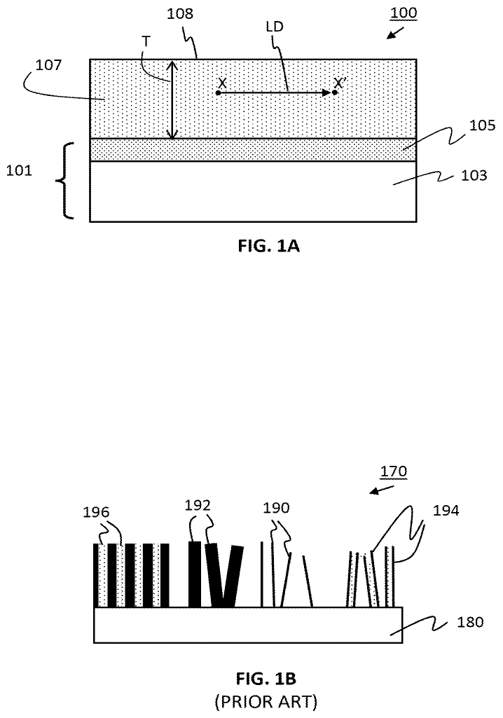

Anodes of the present disclosure may include current collectors having a plurality of grooves. Such groove features are discussed herein, but it is first useful to describe some of the other features of the present anode. FIG. 1A is a cross-sectional view of an anode according to some embodiments of the present disclosure. Anode 100 includes current collector 101 and a lithium storage layer 107 overlaying the current collector. Current collector 101 includes a surface layer 105 provided over an electrically conductive layer 103, for example, an electrically conductive metal layer. Although the figure shows the surface of the current collector as flat for convenience, the current collector may have a rough surface as discussed below. The lithium storage layer 107 is provided over surface layer 105. In some embodiments, the top of the lithium storage layer 107 corresponds to a top surface 108 of anode 100. Lithium storage layer 107 may be characterized by an average thickness T (e.g., mean, median, or mode). In some embodiments the lithium storage layer 107 is in physical contact with the surface layer 105. In some embodiments the lithium storage layer includes a material capable of forming an electrochemically reversible alloy with lithium. In some embodiments, the lithium storage layer includes silicon, germanium, tin, or alloys thereof. In some embodiments the lithium storage layer comprises at least 40 atomic % silicon, germanium, or a combination thereof. In some embodiments, the lithium storage layer is provided by a physical vapor deposition (PVD) process, e.g., by sputtering or e-beam, or by a chemical vapor deposition (CVD) process including, but not limited to, hot-wire CVD or a plasma-enhanced chemical vapor deposition (PECVD). In some embodiments, lithium storage layer 107, or portions thereof, may include a continuous porous lithium storage layer.

In the present disclosure, the lithium storage layer 107, such as a continuous porous lithium storage layer, may be substantially free of high aspect ratio lithium storage nanostructures, e.g., in the form of spaced-apart wires, pillars, tubes or the like, or in the form of regular, linear vertical channels extending through the lithium storage layer. FIG. 1B shows a cross-sectional view of a prior art anode 170 that includes some non-limiting examples of lithium storage nanostructures, such as nanowires 190, nanopillars 192, nanotubes 194 and nanochannels 196 provided over a current collector 180. Unless noted otherwise, the term “lithium storage nanostructure” herein generally refers to a lithium storage active material structure (for example, a structure of silicon, germanium, or their alloys) having at least one cross-sectional dimension that is less than about 2,000 nm, other than a dimension approximately normal to an underlying substrate (such as a layer thickness) and excluding dimensions caused by random pores and channels. Similarly, the terms “nanowires,” “nanopillars,” and “nanotubes” refers to wires, pillars, and tubes, respectively, at least a portion of which, have a diameter of less than 2,000 nm. “High aspect ratio” nanostructures have an aspect ratio greater than 4:1, where the aspect ratio is generally the height or length of a feature (which may be measured along a feature axis aligned at an angle of 45 to 90 degrees relative to the underlying current collector surface) divided by the width of the feature (which may be measured generally orthogonal to the feature axis). In some embodiments, the lithium storage layer is considered “substantially free” of lithium storage nanostructures when the anode has an average (e.g., mean, median, or mode) of fewer than 10 lithium storage nanostructures per 1600 square micrometers (in which the number of lithium storage nanostructures is the sum of the number of nanowires, nanopillars, and nanotubes in the same unit area), such lithium storage nanostructures having an aspect ratio of 4:1 or higher. Alternatively, there is an average of fewer than 1 such lithium storage nanostructures per 1600 square micrometers. In some embodiments, an anode may have patterned regions of lithium storage layer 107 and other regions that may purposefully include lithium storage nanostructures. In such cases, the term “substantially free” may refer just to the patterned regions of the lithium storage layer. As noted below, the current collector may have a high surface roughness or include nanostructures, but these features are separate from the lithium storage layer and not considered to be lithium storage nanostructures.

In some embodiments, deposition conditions are selected in combination with the current collector so that the continuous porous lithium storage layer is relatively smooth providing an anode with diffuse or total reflectance of at least 10% at 550 nm, alternatively at least 20% (measured at the continuous porous lithium storage layer side). In some embodiments, anodes having such diffuse or total reflectance may be less prone to damage from physical handling. In some embodiments, anodes that are not substantially free of lithium storage nanostructure may have lower reflectance and may be more prone to damage from physical handling.

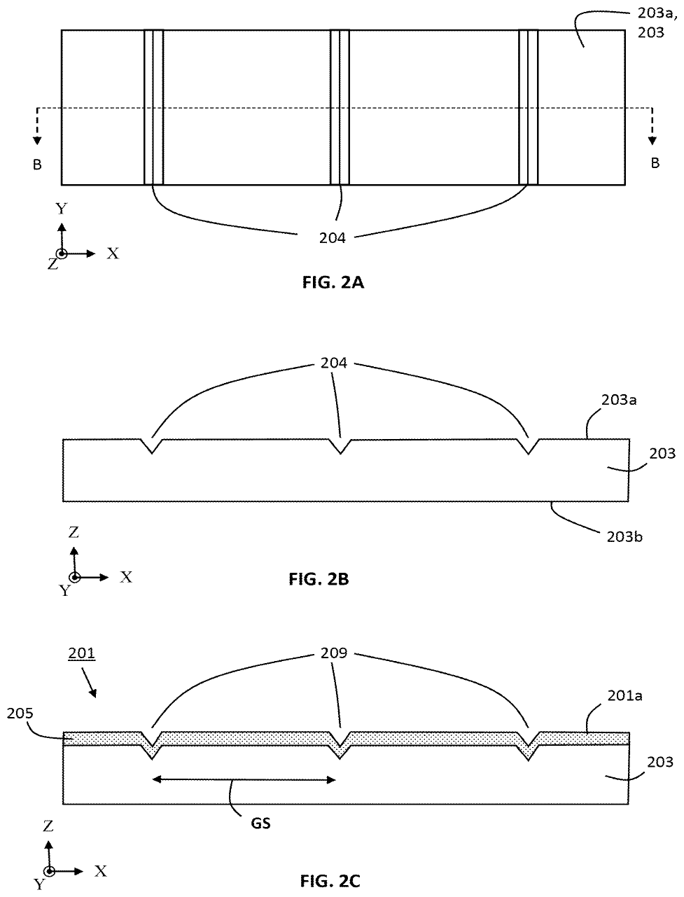

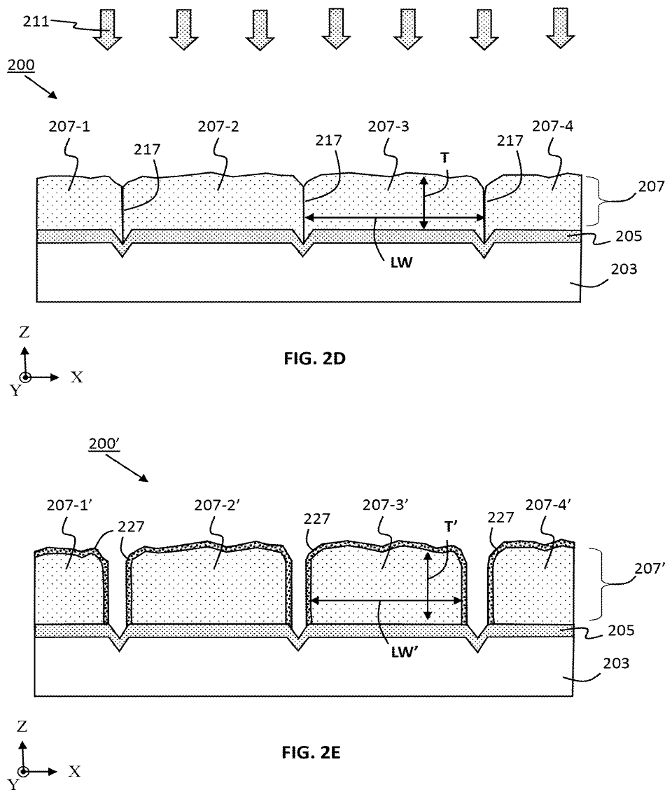

The current collector may include a plurality of grooves in at least one surface. In some embodiments, grooves may be provided in the electrically conductive layer. When forming the surface layer, the groove pattern may then be transferred to the surface layer. FIGS. 2A-FIG. 2D are various views illustrating a method of making an anode according to some embodiments. For added perspective, XYZ coordinate axes are also provided.

FIG. 2A is a plan view of a first surface 203a of electrically conductive layer 203. A plurality of grooves 204 have been formed in the first surface 203a of the electrically conductive layer. Grooves 204 may sometimes be referred to as conductive layer grooves. FIG. 2B is a cross-sectional view of the electrically conductive layer along cut line B-B from FIG. 2A. A second surface 203b of the electrically conductive layer is also labelled in FIG. 2B. Not shown, in some embodiments, the second surface 203b may also include a plurality of grooves that may be similar to, or different from, grooves 204. Although the grooves are shown as parallel and V-shaped, other patterns and shapes may be used. Various options for groove profiles and methods of making grooves are described elsewhere.

FIG. 2C is a cross-sectional view of current collector 201 after forming a surface layer 205 over the first surface 203a of the electrically conductive layer. More details regarding the surface layer are discussed elsewhere. In FIG. 2C, surface layer 205 may be formed so that it is at least partially conformal to the underlying electrically conductive layer. In this way, the pattern of the grooves is at least partially transferred to the surface layer 205, thereby forming grooves 209 provided in a first surface 201a of the current collector 201. That is, in embodiments similar to FIG. 2C, application of a surface layer should not significantly planarize the first surface 203a of the electrically conductive layer 203 because the pattern of grooves may be lost at the first surface of current collector 201. In some embodiments, the transfer to the top surface may be conformal in portions of the grooves or all of the grooves. A groove may be spaced from another groove in a lateral dimension by a groove spacing distance GS. A lateral dimension herein may generally correspond to a dimension that is measured approximately parallel to X-Y plane (e.g., approximately parallel to the average plane defined by the current collector surface). In some cases, the grooves may be characterized along a lateral dimension by an average spacing distance, which may represent the average (e.g., mean, mode, or median) of three or more groove spacing measurements.

In FIG. 2D, lithium storage layer 207 may be formed over the first surface of the current collector 201 by a chemical vapor deposition (CVD) process, using one or more appropriate lithium storage material precursor gasses 211 and conditions to form anode 200. The lithium storage layer may include discontinuities 217 corresponding in part to the locations of the grooves to form a plurality of lithium storage layer segments 207-1, 207-2, 207-3, and 207-4. In some embodiments, the discontinuities may extend through some or all of the lithium storage layer in an average direction approximately orthogonal to the current collector surface, e.g., within 300 of orthogonal. In an SEM cross-section, a discontinuity may appear as a crack or fissure between segments. A complete discontinuity may be when there is no physical contact between adjacent segments. In some embodiments, a segment may partially be in physical contact with an adjacent segment, but the connectivity may be weaker along the discontinuity than the lithium storage material connectivity within a segment. That is, the discontinuity may be partial. Partial discontinuities may include some bridging regions corresponding to where lithium storage layer material connects one segment to another. In some embodiments, an average lateral spacing between adjacent segments may be at least 0.30 nm. In some cases, an average lateral spacing between two adjacent segments may be in a range of 0.3-1 nm, alternatively 1-2 nm, alternatively 2-5 nm, alternatively 5-10 nm, alternatively 10-20 nm, alternatively 20-50 nm, alternatively 50-100 nm, alternatively 100-200 nm, alternatively 200-500 nm, alternatively 500 nm-1 μm, or any combination of ranges thereof.

In some embodiments, discontinuities (partial or complete) may provide improved battery performance. For example, and not being bound by theory, the discontinuities may promote vertical growth (in the Z axis) of the lithium storage layer segment if it swells during lithiation, e.g., when the lithium storage layer material is substantially silicon-based. Lateral swell in some cases may result in increased buckling or deformations of the anode. The grooves and associated discontinuities may reduce the tendency of an anode to buckle or deform during cycling. In some embodiments, a ratio of the average lateral width LW of a lithium storage layer segment to the average thickness T of the lithium storage layer, i.e., the ratio of LW/T may be at least 0.4. In some embodiments, the ratio of LW/T may be less than 50. In some embodiments, the ratio of LW/T may be in a range of 0.4-0.5, alternatively 0.5-0.75, alternatively 0.75-1.0, alternatively 1.0-1.5, alternatively 1.5-2, alternatively 2-3, alternatively 3-4, alternatively 4-5, alternatively 5-7, alternatively 7-10, alternatively 10-15, alternatively 15-20, alternatively 20-25, alternatively 25-30, alternatively 30-40, alternatively 40-50, or any combinations of ranges thereof.

In some cases, the discontinuities may promote predetermined break points in the lithium storage layer during electrochemical formation and/or use-cycling (collectively “electrochemical cycling”). Such predetermined break points may reduce electrochemical formation losses (loss of energy storage capacity), allow for faster charging/discharging, and increase cycle life. They may also enable the use of thinner current collector foil thereby increasing the gravimetric and volumetric density of batteries. In some cases, the discontinuities, which may be at least in part predetermined rather than entirely random, may lessen the amount of lithium storage material that may become out of electrical contact with the current collector. In some embodiments, adjacent lithium storage layer segments may have less or no lateral connectivity after electrochemical cycling. FIG. 2E is a cross-sectional view or a non-limiting example of an anode according to some embodiments. Anode 200′ may in some cases represent anode 200 from FIG. 2D after electrochemical cycling. Anode 200′ may include lithium storage layer 207′ including lithium storage layer segments 207-1′, 207-2′, 207-3′, and 207-4′. Relative to lithium storage layer 207 and its corresponding segments, lithium storage layer 207′ and its segments may in some cases be different structurally or chemically after electrochemical cycling. For example, the discontinuities between segments may be larger in lithium storage layer 207′ so that there may be clear spaces between segments in some cases. In some embodiments, the height or thickness of lithium storage layer 207′ may be larger than the thickness of lithium storage layer 207. Anode 200′ may further include an SEI (Solid-Electrolyte-Interphase) layer 227 formed over the lithium storage layer segments. An SEI layer may be formed during cycling by partial decomposition of the organic solvent and/or the electrolyte. The SEI is generally electrically insulating but ionically conductive, thereby allowing lithium ions to pass through. The SEI may lessen decomposition of the electrolyte in later electrochemical cycling. In some embodiments, a ratio of the average lateral width LW′ of a lithium storage layer segment after electrochemical cycling to the average thickness T′ of the lithium storage layer, after electrochemical cycling i.e., the ratio of LW′/T′ may be at least 0.3. In some embodiments, the ratio of LW/T may be less than 50. In some embodiments, the ratio of LW/T may be in a range of 0.3-0.4, alternatively 0.4-0.5, alternatively 0.5-0.75, alternatively 0.75-1.0, alternatively 1.0-1.5, alternatively 1.5-2, alternatively 2-3, alternatively 3-4, alternatively 4-5, alternatively 5-7, alternatively 7-10, alternatively 10-15, alternatively 15-20, alternatively 20-25, alternatively 25-30, alternatively 30-40, alternatively 40-50, or any combinations of ranges thereof.

In some cases, it may be desirable for the underlying electrically conductive layer to generally not be exposed directly to electrolyte during electrochemical cycling. For example, and not being bound by theory, there may be an increased tendency to plate lithium metal and form dendrites on exposed portions of a metallic electrically conductive layer. In some cases, an exposed metallic surface of an electrically conductive layer may promote or catalyze other unwanted electrochemical reactions at the electrolyte/metal interface. However, in embodiments such as shown in FIGS. 2C-2E, the electrically conductive layer 203 may be covered by the surface layer 205, even in the groove area.

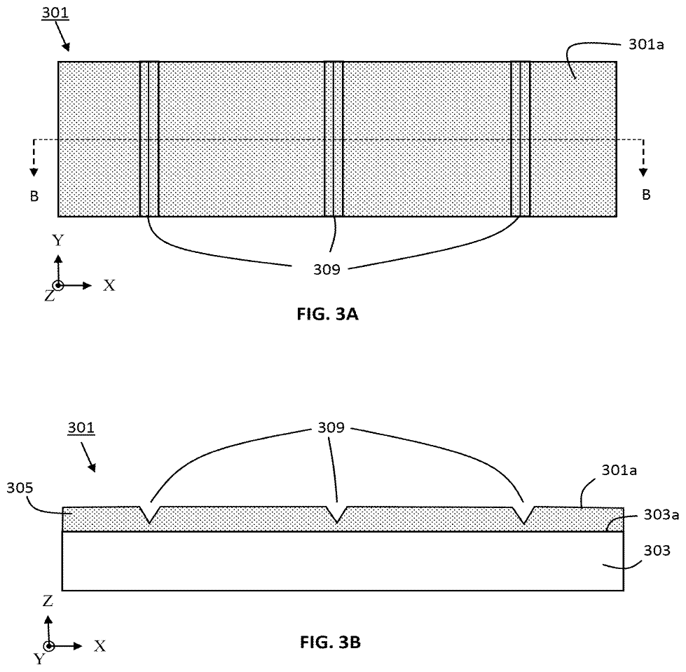

There are other methods and designs where a groove may be provided in the current collector without exposing an underlying electrically conductive layer. For example, current collector grooves may be formed solely in a surface layer. FIG. 3A is a plan view of a non-limiting example of a current collector according to some embodiments. FIG. 3B is a cross-sectional view along cut line B-B from FIG. 3A. A plurality of grooves 309 has been formed in the first surface 301a of current collector 301. Although not shown, a lithium storage layer may be deposited to form an anode that may have properties similar to those described with respect to FIGS. 2D and 2E.

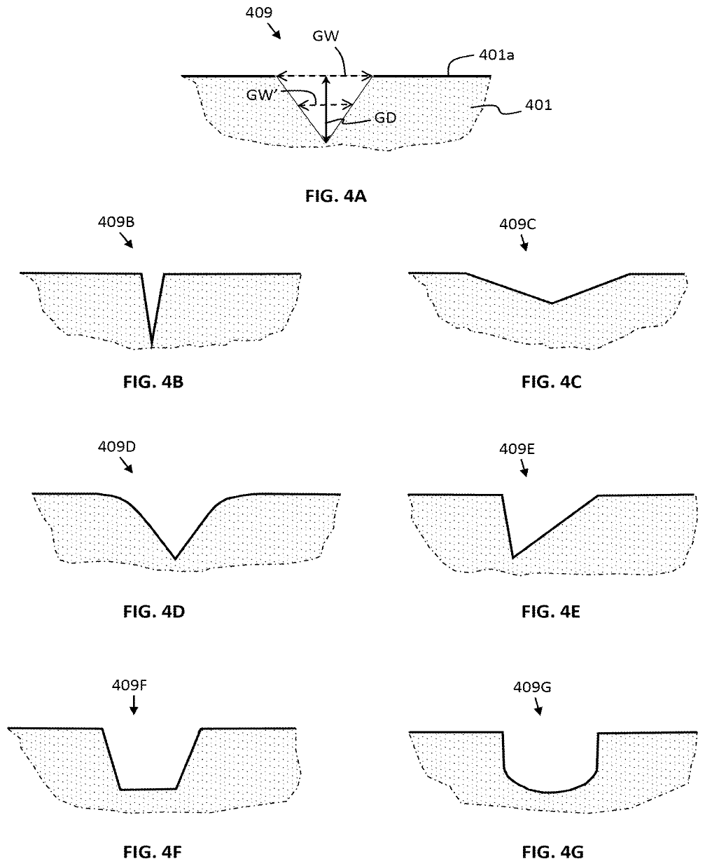

FIG. 4A is a cross-sectional view of a non-limiting example of a groove according to some embodiments. For simplicity, the figure only shows a portion of the current collector 401 and does not explicitly illustrate the electrically conductive layer or surface layer. The current collector structure may be similar to that shown in FIG. 2C or FIG. 3B or some other embodiment. In some cases, a groove 409 may have a groove depth GD and a groove width GW. In some cases, the groove depth GD may be measured as an approximately orthogonal distance from an imaginary line or plane corresponding to the top of first surface 401a in the current collector down to a deepest point furthest from the top of first surface 401a. A groove width GW may in some cases represent the distance bridging the tops of each side of the groove. As shown, GW may sometimes be referred to as a maximum groove width or a surface groove width. In some embodiments, a groove width may correspond to a width within the groove. For example, in FIG. 4A, GW′ may correspond to the groove width measured halfway down groove depth GD. This may sometimes be referred to as the half-max groove width. Other metrics may be similarly used.

In some embodiments, the ratio of groove width (GW or GW′) to groove depth GD may be less than 10, alternatively less than 5, alternatively less than 3. In some embodiments, the ratio of groove width to groove depth may be in a range of 0.2-0.3, alternatively 0.3-0.5, alternatively 0.5-1.0, alternatively 1.0-1.5, alternatively 1.5-2.0, alternatively 2-3, alternatively 3-4, alternatively 4-5, alternatively 5-10, or any combination of ranges thereof.

In some embodiments, the grooves may be characterized by an average (e.g., mean, median, or mode) groove depth GD that may be at least 50 nm, alternatively at least 100 nm, alternatively at least 200 nm, alternatively at least 300 nm, alternatively at least 500 nm, alternatively at least 1000 nm, alternatively at least 1500 nm, alternatively at least 2000 nm, alternatively at least 3000 nm, alternatively at least 4000 nm, alternatively at least 5000 nm. In some cases, the grooves may be characterized by an average groove depth in a range of 50-100 nm, 100-200 nm, 200-300 nm, 300-500 nm, 500-1000 nm, 1000-1500 nm, 1500-2000 nm, 2000-3000 nm, 3000-4000 nm, 4000-5000 nm, or any combination of ranges thereof.

In some embodiment, the grooves may be characterized by an average groove depth that is no more than about 0.4× the average thickness of the lithium storage layer, alternatively no more than 0.3×, alternatively no more than 0.25×, alternatively no more than 0.2×. In some cases, a ratio of the average groove depth to the average thickness of the lithium storage layer (e.g., measured along a lateral dimension across at least one 400 μm portion of the current collector) may be in a range of 0.02-0.05, 0.05-0.10, 0.10-0.15, 0.15-0.20, 0.25-0.30, 0.30-0.40, or any combination of ranges thereof.

The groove depth may in some cases vary randomly or deliberately across its length. For example, as described later, grooves may be made by laser etching. The laser power can be controlled during etching to alter the depth. In some cases when there are grooves that cross each other, the groove depth may be larger at or near the intersections. In some embodiments, the length of a groove may be at least 10 μm, alternatively at least 20 μm, at least 30 μm, at least 40 μm, at least 50 μm, at least 75 μm, at least 100 μm, at least 200 μm, at least 300 μm, or at least 500 μm.

A groove may have cross-sectional profiles that are different from FIG. 4A. A large variety of profiles may be used. FIGS. 4B-4G are cross-sectional views of non-limiting examples of grooves according to some embodiments. For clarity, labeling of features is limited, but their identities are evident with reference to FIG. 4A, and other figures. In some embodiments, a groove such as 409B may have a high aspect ratio where the groove is deeper than wide. A groove such as 409C may have a low aspect ratio where the groove is wider than it is deep. A groove such as 409D may be rounded near the top of the groove, i.e., near the interface with the top of first surface. A groove such as 409E may be asymmetric where the deepest portion is not at or near the center of the groove width. A groove such as 409F may have a relatively flat bottom. A groove such as 409G may have a rounded bottom. A groove may combine certain features of any of FIGS. 4A-4G.

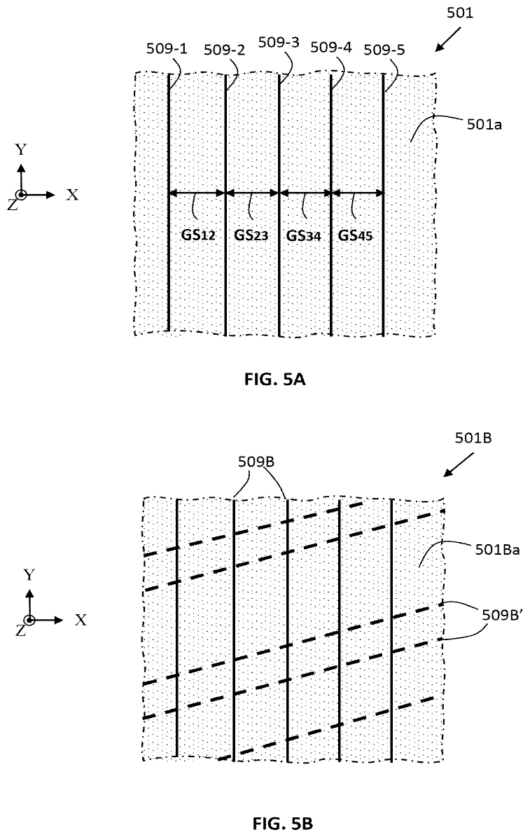

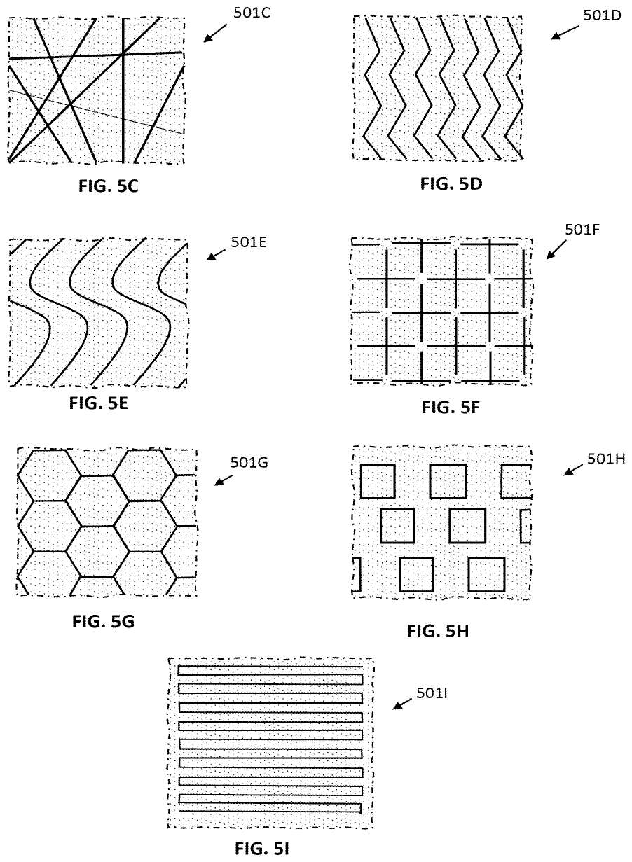

FIG. 5A is a plan view of a non-limiting example of a current collector according to some embodiments. For simplicity, a representative surface area is shown. Current collector 501 may include a first surface 501a in which a plurality of grooves is formed, including grooves 509-1, 509-2, 509-3, 509-4, and 509-5. In some embodiments, the grooves may be substantially parallel to each other, e.g., parallel to the Y axis. In some cases, substantially parallel grooves may be those that are within about 10° of parallel, alternatively within about 5° of parallel. The groove spacings GS₁₂, GS₂₃, GS₃₄, GS₄₅, may be measured along a lateral dimension, e.g., parallel to the X axis. In some cases, the groove spacing may be measured along an axis orthogonal to the grooves. In some embodiments an average groove spacing, e.g., measured along a lateral dimension across at least one 400 μm portion of the current collector (or a length sufficient to find 3 or more grooves), is in a range of 10-15 μm, alternatively 15-20 μm, alternatively 20-30 μm, alternatively 30-40 μm, alternatively 40-50 μm, alternatively 50-60 μm, alternatively 60-80 μm, alternatively 80-100 μm, alternatively 100-120 μm, alternatively 120-150 μm, or any combination of ranges thereof. In some embodiments, a particularly useful average groove spacing may be in a range of 15-80 μm, or alternatively 20-50 μm. The groove spacings may in some embodiments be relatively uniform, as shown in FIG. 5A. For example, the average of groove spacings may have a % standard deviation of less than 40%, alternatively less than 30%, alternatively less than 20%. In some embodiments, the groove spacings may have significant variation. For example, the average of the groove spacings may have a % standard deviation of 40% or more, alternatively 50% or more.

In some embodiments, in at least one lateral dimension, a ratio of the average groove spacing GS to the average thickness T of the lithium storage layer, i.e., the ratio of GS/T, may be at least 0.4. In some embodiments, the ratio of GS/T may be less than 50. In some embodiments, the ratio of GS/T may be in a range of 0.4-0.5, alternatively 0.5-0.75, alternatively 0.75-1.0, alternatively 1.0-1.5, alternatively 1.5-2, alternatively 2-3, alternatively 3-4, alternatively 4-5, alternatively 5-7, alternatively 7-10, alternatively 10-15, alternatively 15-20, alternatively 20-25, alternatively 25-30, alternatively 30-40, alternatively 40-50, or any combinations of ranges thereof.

In some cases, in at least one lateral dimension, an average number of grooves (e.g., as measured along a 4 mm portion of the lateral dimension) may be in a range of 3-5, alternatively 5-10, alternatively 10-20, alternatively 20-50, alternatively 50-100, alternatively 100-200, alternatively 200-300, alternatively 300-400, alternatively 400-500, alternatively 500-600, alternatively 600-800, alternatively 800-1000, or any combination of ranges thereof. In some embodiments, a particularly useful average number of grooves along a 4 mm lateral distance may be in a range of 50-300, or alternatively 80-200.

In some embodiments, the grooves may include a first set of substantially parallel grooves that intersect with a second set of substantially parallel grooves. For example, the grooves of FIG. 5A may represent a first set of substantially parallel grooves. FIG. 5B is a plan view of a non-limiting example of a current collector according to some embodiments. For simplicity, a representative surface area is shown. Current collector 501B may include a first surface 501Ba in which a first set of substantially parallel grooves 509B (solid lines). A second set of substantially parallel grooves 509B′ (dashed lines) may also be provided at an angle to the first set. In some embodiments, the average angle of intersection (which may be measured using the acute angle or using the obtuse angle) may be in range of 150 to 165°, alternatively 30° to 150°, alternatively 45° to 135°, alternatively 60° to 120°, alternatively 750 to 105°, alternatively 800 to 100°, or alternatively 85° to 95°. In some cases, the average angle of intersection may be about 90°. The average groove spacing of the first set of grooves may be the same or different than the groove spacing of the second set of grooves. The % standard deviations of each set of groove spacings may be the same or different. Although not shown in FIG. 5B, the current collector may include a third set of substantially parallel grooves, or even a fourth or more. Alternatively, one set of grooves may be substantially parallel, but another set of grooves is not.

There are numerous variations for the patterns that may be made by the grooves. FIGS. 5C-51 are plan views of non-limiting examples of current collectors according to some embodiments. For simplicity, a representative surface area is shown for each. In some embodiments, a current collector such as 501C may have a plurality of grooves forming a random pattern. In some embodiments, one or more grooves may not be straight. For example, a current collector such as 501D may have grooves characterized by a zig-zag pattern. A current collector such as 501E may have curved grooves. In some embodiments, the grooves may be discontinuous. For example, a current collector such as 501F may have a plurality of cross-shaped grooves. In some embodiments, the grooves may form a geometric pattern. For example, a current collector such as 501G may include a honeycomb pattern of hexagonal grooves. In some embodiments, the plurality of grooves may form separated shapes. For example, a current collector such as 501H may include a plurality of square-shaped grooves. A plurality of grooves may be in at least one lateral direction. In some embodiments, the plurality of grooves may be connected together to form a single, continuous channel. The plurality of grooves may be connected by a second plurality of grooves aligned in a different direction (e.g., perpendicular) to the first plurality of grooves. For example, a current collector such as 501I may include a sinusoidal, continuous channel formed in part by the plurality of grooves. FIGS. 5A-51 illustrate just a few examples of groove patterns. Many other patterns may be used that are not shown here. The choice of groove pattern may depend in part on manufacturability of forming such grooves and/or the effect of the groove pattern on device performance, e.g., through improved stress relief during electrochemical cycling.

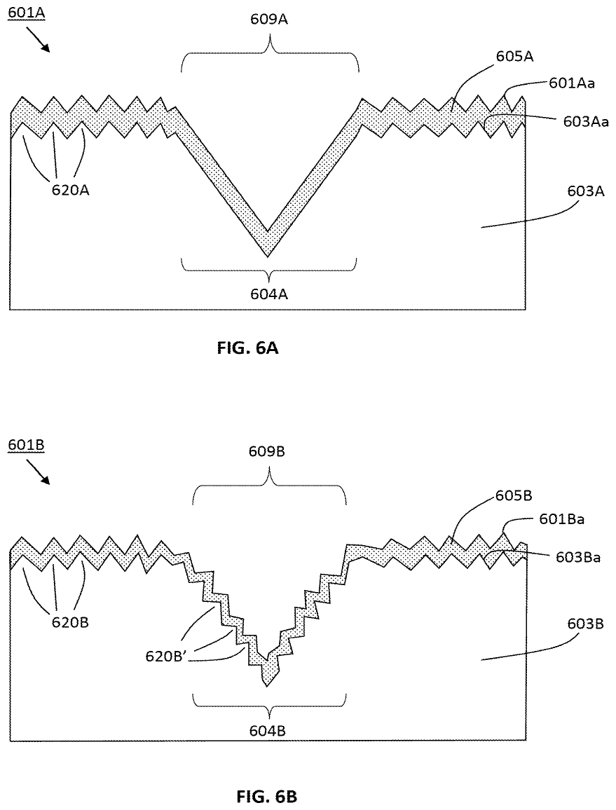

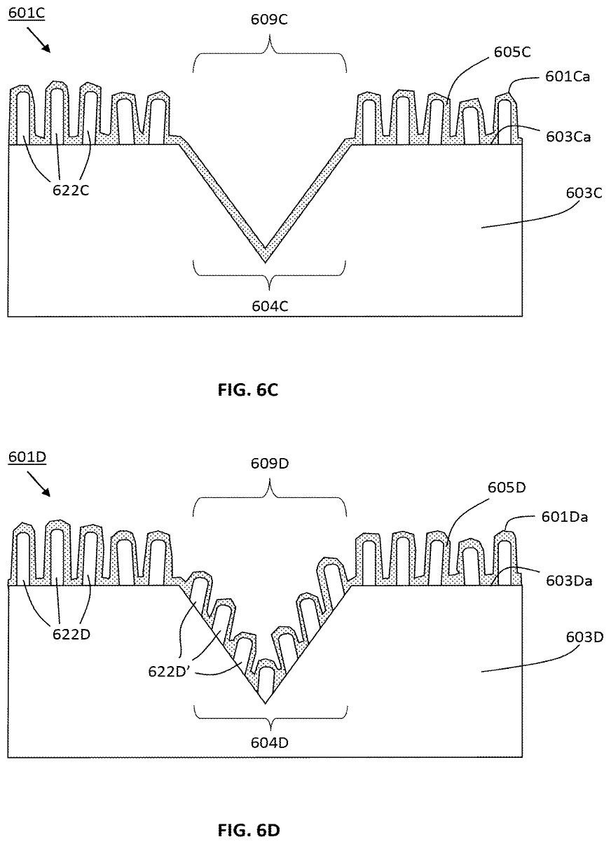

In some embodiments the surface of the current collector may have a rough surface or surface roughening features. Surface roughening features are discussed in more detail elsewhere herein. FIGS. 6A-6D are cross-sectional views of non-limiting examples of current collectors according to some embodiments. Turning first to FIG. 6A, current collector 601A may include electrically conductive layer 603A. The surface 603Aa of the electrically conductive layer may include roughening features 620A. Electrically conductive layer 603A may include a plurality of conductive layer grooves such as conductive layer groove 604A. A surface layer 605A may be formed over the electrically conductive layer that is at least partially conformal to the underlying electrically conductive layer. In this way, the pattern of the grooves is at least partially transferred to the top of the surface layer 605A, thereby forming grooves such as 609A in the surface 601Aa of the current collector 601A. As shown in FIG. 6A, the surface layer may in some cases also coat the surface roughening features in a conformal or partially conformal manner. Alternatively, in some cases the surface roughness of the electrically conductive layer may be substantially planarized while preserving the presence of the groove in the current collector surface. In some cases, one or more dimensions of the groove is larger than one or more dimensions of the surface roughening features. For example, the average groove depth may be larger than an average roughness depth (which may be measured as a peak-to-valley vertical distance in the top of the surface layer 605A or in the top of the electrically conductive layer 603A. In some embodiments, relative to an average roughness depth, an average groove depth (e.g., measured along a lateral dimension across at least one 400 μm portion of the current collector) may be at least 20% larger, alternatively at least 30% larger, alternatively at least 40% larger, alternatively at least 50% larger, alternatively at least 75% larger, alternatively at least 100% larger. In some embodiments, relative to an average roughening feature depth, an average groove depth (e.g., measured along a lateral dimension across at least one 400 μm portion of the current collector) may be in a range of 1.2-1.5×, 1.5×-2×, 2-3×, 3-4×, 4-5×, 5-7×, 7-10×, 10-15×, 15-20×, or any combination of ranges thereof.

In some cases, there may be more surface roughening features (e.g., valleys or peaks) than grooves. For example, as shown in the cross section of FIG. 6A, there are many more roughening features than grooves. That is, the surface roughening features may in some cases be described as having a higher lateral frequency or shorter spacing relative to the grooves. In some cases, the number of roughening features relative to grooves (e.g., measured along a lateral dimension across at least one 400 μm portion of the current collector) may be in a range of 1.2-1.5×, 1.5×-2×, 2-3×, 3-4×, 4-5×, 5-7×, 7-10×, 10-15×, 15-20×, 20-30×, 30-50×, or any combination of ranges thereof. In some embodiments, as shown in FIG. 6A, the surface roughening features may not be substantially present in the conductive layer groove 604A.

Current collector 601B of FIG. 6B may be similar to 601A in some regards, and may include electrically conductive layer 603B having a conductive layer groove 604B and surface 603Ba that includes surface roughening features 620B. A surface layer 605B may be provided over the electrically conductive layer, thereby forming groove 609B in a surface 601Ba of the current collector. Current collector 601B may further include roughening features 620B′ provided in the conductive layer groove 604B. The roughing features 620B′ may be substantially the same as those of 620B, or they may be different.

Referring to FIG. 6C, current collector 601C may include electrically conductive layer 603C. The surface 603Ca of the electrically conductive layer may include roughening features. In FIG. 6C, the roughening features may be nanopillar features 622C. Electrically conductive layer 603C may include a plurality of conductive layer grooves such as conductive layer groove 604C. A surface layer 605A may be formed over the electrically conductive layer that is at least partially conformal to the underlying electrically conductive layer. In this way, the pattern of the grooves is at least partially transferred to the top of the surface layer 605C, thereby forming grooves such as 609C in the surface 601Ca of the current collector 601C. As shown in FIG. 6C, the surface layer may in some cases also coat the nanopillar features in a conformal or partially conformal manner.

Current collector 601D of FIG. 6D may be similar to 601C in some regards, and may include electrically conductive layer 603D, nanopillar features 622D provided/on surface 603Da of the electrically conductive layer, a conductive layer groove 604D, and a surface layer 605D provided over the electrically conductive layer, thereby forming groove 609D in a surface 601Da of the current collector. Current collector 601D may further include roughening features, e.g., nanopillar features 622B′ provided in the conductive layer groove 604D. The nanopillar features 622D′ may be substantially the same as those of 622D, or they may be different. In some embodiments, roughening and nanopillar features may be as those described in U.S. patent application Ser. No. 18/010,737, which is incorporated by reference herein for all purposes.

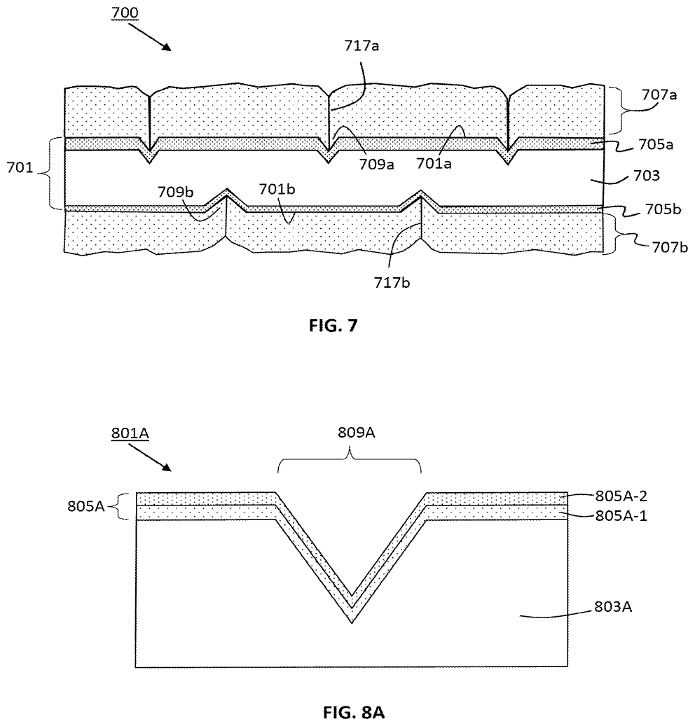

Anodes of the present disclosure may optionally be two-sided. For example, FIG. 7 is a cross-sectional view of a non-limiting example of an anode according to some embodiments. The current collector 701 may include electrically conductive layer 703 and surface layers (705a, 705b) provided on either side of the electrically conductive layer 703. First-side grooves 709a may be provided in a first surface 701a of the current collector and second-side grooves 709b may be provided in a second surface 701b of the current collector. The first-side grooves may or may not align with the second-side grooves. The first-side grooves may have a similar shape and size as the second-size grooves, or they may be different. Lithium storage layers (707a, 707b) are disposed on both sides to form anode 700. As discussed, the grooves may induce discontinuities (717a, 717b) in the respective lithium storage layers. Surface layers 705a and 705b may be the same or different with respect to composition, thickness, roughness or some other property. Similarly, lithium storage layers 707a and 707b may be the same or different with respect to composition, thickness, porosity or some other property.

### Current Collector/Electrically Conductive Layer

In some embodiments, the current collector or the electrically conductive layer may be characterized by a tensile strength Rm or a yield strength Re. In some cases, the tensile and yield strength properties of the current collector are dependent primarily on the electrically conductive layer, which in some embodiments, may be thicker than the surface layer. If the tensile strength is too high or too low, it may be difficult to handle in manufacturing such as in roll-to-roll processes. During electrochemical cycling of the anode, deformation of the anode may occur if the tensile strength is too low, or alternatively, adhesion of the lithium storage layer may be compromised if the tensile strength is too high.

Deformation of the anode is not necessarily a problem for all products, and such deformation may sometimes only occur at higher capacities, i.e., higher loadings of lithium storage layer material. For such products, the current collector or electrically conductive layer may be characterized by a tensile strength Rₘ in a range of 100-150 MPa, alternatively 150-200 MPa, alternatively 200-250 MPa, alternatively 250-300 MPa, alternatively 300-350 MPa, alternatively 350-400 MPa, alternatively 400-500 MPa, alternatively 500-600 MPa, alternatively 600-700 MPa, alternatively 700-800 MPa, alternatively 800-900 MPa, alternatively 900-1000 MPa, alternatively 1000-1200 MPa, alternatively 1200-1500 MPa, or any combination of ranges thereof.

In some embodiments, significant anode deformation should be avoided, but low battery capacities may not be acceptable. For example, in some cases when the anode includes 7 μm or more of amorphous silicon and/or the electrochemical cycling capacity is 1.5 mAh/cm² or greater, a current collector or electrically conductive layer may be selected that is characterized by a tensile strength Rₘ of greater than 450 MPa, alternatively greater than 500 MPa, alternatively greater than 550 MPa or alternatively greater than 600 MPa. In such embodiments, the tensile strength may be in a range of about 450-500 MPa, alternatively 500-550 MPa, alternatively 550-600 MPa, alternatively 600-650 MPa, alternatively 650-700 MPa, alternatively 700-750 MPa, alternatively 750-800 MPa, alternatively 800-850 MPa, alternatively 850-900 MPa, alternatively 900-950 MPa, alternatively 950-1000 MPa, alternatively 1000-1200 MPa, alternatively 1200-1500 MPa, or any combination of ranges thereof. In some embodiments, the current collector or electrically conductive layer may have a tensile strength of greater than 1500 MPa. In some embodiments, the current collector or electrically conductive layer is in the form of a foil having a tensile strength of greater than 600 MPa and an average thickness in a range of 4-8 μm, alternatively 8-10 μm, alternatively 10-14 μm, alternatively 14-18 μm, alternatively 18-20 μm, alternatively 20-25 μm, alternatively 25-30 μm, alternatively 30-40 μm, alternatively 40-50 μm, or any combination of ranges thereof.

In some embodiments the electrically conductive layer may have a conductivity of at least 103 S/m, or alternatively at least 10⁶ S/m, or alternatively at least 10⁷ S/m, and may include inorganic or organic conductive materials or a combination thereof. For anodes having low capacity and/or where there are no concerns regarding anode deformation during use, a wide variety of conductive materials may be used as the electrically conductive layer.

In some embodiments, the electrically conductive layer includes a metallic material, e.g., titanium (and its alloys), nickel (and its alloys), copper (and its alloys), or stainless steel. In some embodiments, the electrically conductive layer includes an electrically conductive carbon, such as carbon black, carbon nanotubes, graphene, graphene oxide, reduced graphene oxide, and graphite. In some embodiments the electrically conductive layer may be in the form of a foil or sheet of conductive material. In some embodiments, the electrically conductive layer may include multiple layers of different electrically conductive materials. The electrically conductive layer may be in the form of a layer deposited onto an insulating substrate (e.g., a polymer sheet or ceramic substrate coated with a conductive material, including but not limited to, nickel or copper, optionally on both sides).

When higher tensile strength is desirable, e.g., where Rₘ is greater than 450 MPa, alternatively greater than 500 MPa, alternatively greater than 550 MPa, or alternatively greater than 600 MPa, the electrically conductive layer may include nickel (and certain alloys), or certain copper alloys, such as brass (an alloy primarily of copper and zinc), bronze (an alloy primarily of copper and tin), CuMgAgP (an alloy primarily of copper, magnesium, silver, and phosphorous), CuFe2P (an alloy primarily of copper, iron, and phosphorous), CuNi3Si (an alloy primarily of copper, nickel, and silicon), CuCrZr (an alloy primarily of copper, chromium, and zirconium), and CuCrSiTi (an alloy primarily of copper, chromium, silicon, and titanium). The nomenclature for metal alloys is not the stoichiometric molecular formula used in chemistry but rather the nomenclature used by those of ordinary skill in the alloy arts. For example, CuNi3Si does not mean there are three atoms of nickel and one atom of silicon for each atom of copper. In some embodiments these nickel- or copper-based higher tensile electrically conductive layers may include roll-formed nickel or copper alloy foils.

In some embodiments, any of the above-mentioned electrically conductive layers (low or high tensile strength) may act as a primary electrically conductive layer and further include an electrically conductive interlayer, e.g., a metal interlayer, disposed between the primary electrically conductive layer and the surface layer. For example, an electrically conductive layer may be similar to those described in PCT International Publication Number WO2022/005999, which is incorporated by reference herein in its entirety for all purposes.

The metal interlayer may be applied by, e.g., by sputtering, vapor deposition, electrolytic plating, or electroless plating, or any convenient method. The metal interlayer generally has an average thickness of less than 50% of the average thickness of the total electrically conductive layer, i.e., the combined thickness of primary electrically conductive layer and metal interlayer(s). In some embodiments, the surface layer may form more uniformly over, or adhere better to, the metal interlayer than to the primary electrically conductive layer.

Grooves may be formed using various methods in either the electrically conductive layer (e.g., as in FIG. 2A-2C) or solely in the surface layer (e.g., as in FIGS. 3A and 3B). For convenience, the material or structure in which grooves are formed may simply be referred to herein as the substrate. For example, grooves may be physically formed using a scoring tool having appropriately shaped and sized features that scrapes away surface material from the substrate to a desired depth and pattern. Some pressure, heat, cooling, sonication, or even fluids (e.g., lubricating or cleaning fluids) may also be applied during the scoring. In some cases, the scoring tool may move across the substrate. Parallel grooves may optionally be formed, but other groove patterns may be applied by appropriate movement of the scoring tool. In some embodiments, the substrate may move across the scoring tool. In some cases, the substrate may be in roll-to-roll format and the scoring tool may be positioned between two rollers and drawn across the scoring tool active surface. One side or both sides of the substrate may be treated. In some cases, parallel lines may be formed, but alternatively, a zig-zag or curved pattern may be provided by moving the scoring tool from side to side (orthogonal to the direction of substrate transport) while the substrate moves across. In some cases, even more complex patterns may be formed. In some cases, the scoring tool may be or include a sandpaper structure (a hard grit adhered to a substrate). In some embodiments, e.g., when the substrate includes a hard material such as a high tensile foil, a substrate may have a surface layer or metal interlayer that may be softer or more malleable. than an underlying interior layer. That is, the electrically conductive layer may have a multilayer structure having an outer electrically conductive sublayer that is softer than an interior electrically conductive sublayer, where the outer sublayer is disposed closer to the lithium storage layer than the interior sublayer is to the lithium storage layer. In some embodiments, the substrate with grooves may undergo a cleaning treatment to remove debris or the like.

In some embodiments, grooves may be physically formed by embossing. For example, an embossing surface with a predetermined raised pattern may be used to imprint the desired groove pattern, optionally, with pressure and/or heating. In some cases, embossing may be performed at or near the end of a roll forming process that may be used to make some types of metal foils, e.g., various copper foils. In some embodiments, e.g., when the substrate includes a hard material such as a high tensile foil, a substrate may have a surface layer or metal interlayer that may be softer or more malleable. than an underlying interior layer. That is, the electrically conductive layer may have a multilayer structure having an outer electrically conductive sublayer that is softer or malleable than an interior electrically conductive sublayer, where the outer sublayer is disposed closer to the lithium storage layer than the interior sublayer is to the lithium storage layer.

In some embodiments, the grooves may be formed in a substrate by patterned etching. Patterned etching may be achieved by patterned printing of an etchant or by suitable lithographic methods which may in some cases use a resist material. Etching may use wet etching or dry etching such as plasmas. In some embodiments, patterned etching may employ a laser. In some embodiments, e.g., when the substrate includes a material that is difficult to etch, the substrate may have a surface layer or metal interlayer that may be easier to etch. Than an underlying interior layer. That is, the electrically conductive layer may have a multilayer structure having an outer electrically conductive sublayer that is easier to etch than an interior electrically conductive sublayer, where the outer sublayer is intended to be disposed closer to the lithium storage layer than the interior sublayer is to the lithium storage layer.

In some embodiments, the grooves may be formed by an additive process, e.g., by patterned plating or some other deposition process. In some cases, a resist may be applied in the desired groove pattern and material is plated or deposited around the resist thereby forming the groove.

In some embodiments, the current collector may be characterized as having a surface roughness. In some embodiments, the top surface 108 of the lithium storage layer 107 may have a lower surface roughness than the surface roughness of current collector 101. Herein, surface roughness comparisons and measurements may be made using the Roughness Average (Rₐ), RMS Roughness (R_{q}), Maximum Profile Peak Height roughness (Rₚ), Average Maximum Height of the Profile (R_{z}), or Peak Density (P_{c}). The foregoing measurements are typically made along a measurement trace. In some embodiments, the current collector may be characterized as having both a surface roughness R_{z}≥2.5 μm and a surface roughness Rₐ≥0.25 μm. In some embodiments, R_{z} is in a range of 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0 to 10 μm, 10 to 12 μm, 12 to 14 μm or any combination of ranges thereof. In some embodiments, Rₐ is in a range of 0.25-0.30 μm, alternatively 0.30-0.35 μm, alternatively 0.35-0.40 μm, alternatively 0.40-0.45 μm, alternatively 0.45-0.50 μm, alternatively 0.50-0.55 μm, alternatively 0.55-0.60 μm, alternatively 0.60-0.65 μm, alternatively 0.65-0.70 μm, alternatively 0.70-0.80 μm, alternatively 0.80-0.90 μm, alternatively 0.90-1.0 μm, alternatively 1.0-1.2 μm, alternatively 1.2-1.4 μm, or any combination of ranges thereof.

Other roughness metrics may include measurements made over an area rather than a trace. These may include average roughness (Sa), maximum height (Sz), skewness (Ssk), kurtosis (Sku), maximum peak height (Sp), root mean square roughness (Sq), surface void volume (Sv), surface bearing index (Sbi), core void volume (Sc), surface material volume (Sm), valley fluid retention index (Svi), or some other surface area-based roughness metric. In some embodiments, Sa is in a range of 400-450 nm, alternatively 450-500 nm, alternatively 500-550 nm, alternatively 550-600 nm, alternatively 600-700 nm, alternatively 700-800 nm, alternatively 800-1000 nm, alternatively 1000-1100 nm, alternatively 1100-1200 nm, alternatively 1200-1300 nm, alternatively 1300-1400 nm, alternatively 1400-1500 nm, alternatively 1500-1600 nm, or any combination of ranges thereof.

In some embodiments, some or most of the surface roughness of the current collector may be imparted by the electrically conductive layer and/or a metal interlayer. Alternatively, some or most of the surface roughness of the current collector may be imparted by the surface layer. The presence of grooves is also expected to add to the overall surface roughness of the current collector. In some cases, a combination of the electrically conductive layer, metal interlayer, surface layer, and grooves may collectively contribute substantially to the surface roughness.

In some embodiments, the electrically conductive layer may include roughening features, e.g., electrodeposited roughening features, to increase surface roughness. In some embodiments, the electrodeposited roughening features may include copper features. Alternatively, or in combination with the roughening features, the electrically conductive layer may undergo another electrochemical, chemical, or physical treatment to impart a desired surface roughness prior to formation of the surface layer.

In some embodiments, the roughening features may be characterized as nanopillar features as mentioned elsewhere. In some embodiments, the roughening features may be broad roughness features and appear, e.g., as bumps and hills, in some cases separated on average by at least about 2 μm.

In some embodiments, roughening of the electrically conductive layer may include, for example, physical abrasion (such as sandpaper, sand blasting, polishing, or the like), ablation (such as by laser ablation), embossing, stamping, casting, imprinting, chemical treatments, electrochemical treatments, or thermal treatments. In some cases, such roughening may be used to form one or more of the roughening features described above, e.g., nodular features, nanopillar features, broad roughness features, pitted features or the like. In some cases, roughening features may be random, or alternatively, may be patterned. In some embodiments, surface roughening features and grooves may be formed in a common step. Alternatively, grooves may be formed prior to or after formation of optional surface roughening features.

### Surface Layer

In some embodiments, a surface layer may provide a chemical composition that promotes formation of an adherent lithium storage layer, such as a lithium storage layer deposited by a CVD process, particularly at commercially useful loadings or thicknesses of the lithium storage layer. In some cases, deposition onto an electrically conductive layer alone may be insufficient to provide even initial adhesion such that the lithium storage layer material readily brushes or peels off. Even when there is satisfactory initial adherence, it may be insufficient during electrochemical formation and cycling. Some non-limiting examples of surface layers are discussed below. In some cases, a surface layer may include two or more distinct surface sublayers having different chemical compositions. In some cases, a surface layer or even a surface sublayer may include a mixture of different surface layer materials.

The thickness of a surface layer or a surface sublayer may be as low as a monolayer in some embodiments. In some embodiments, the thickness of the surface layer is in a range of 0.0001 μm to 0.0002 μm, alternatively 0.0002 μm to 0.0005 μm, alternatively 0.0005 μm to 0.001 μm, alternatively 0.001 μm to 0.005 μm, alternatively 0.002 μm to 0.005 μm, alternatively, 0.005 μm to 0.01 μm, alternatively 0.01 μm to 0.02 μm, alternatively 0.02 μm to 0.03 μm, alternatively 0.03 μm to 0.05 μm, alternatively 0.05 μm to 0.1 μm, alternatively 0.1 μm to 0.2 μm, alternatively 0.2 μm to 0.5 μm, alternatively 0.5 μm to 1 μm, alternatively 1 μm to 2 μm, alternatively 2 μm to 5 μm or any combination of ranges thereof.

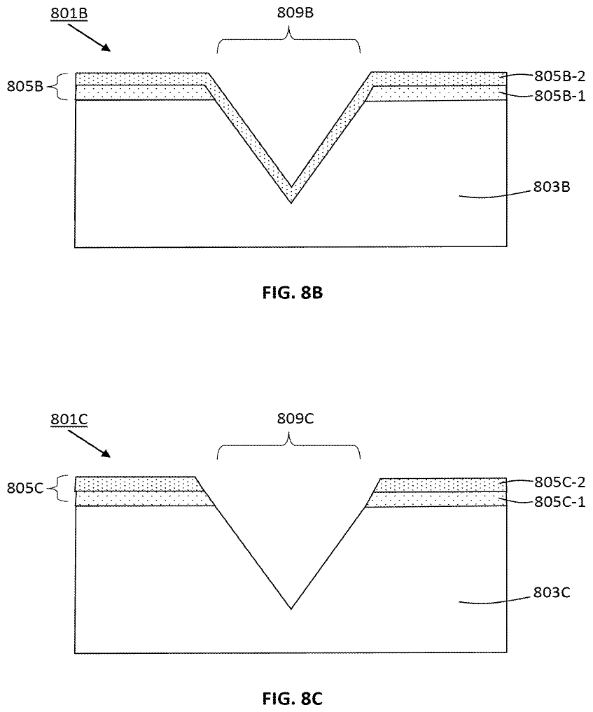

FIGS. 8A-8C are cross sectional views of some non-limiting examples of current collectors according to some embodiments. In FIG. 8A, current collector 801A may include a surface layer 805A having first and second surface sublayers, 805A-1 and 805A-2, respectively, provided over electrically conductive layer 803A. Current collector 801A may include groove 809A provided in its surface. In this case, both surface sublayers extend into the grooves. Such a structure may be made, e.g., by first forming grooves in the electrically conductive layer followed by depositing or otherwise forming the surface layers.

In FIG. 8B, current collector 801B may include surface layer 805B having first and second surface sublayers, 805B-1 and 805B-2, respectively, provided over electrically conductive layer 803B. Current collector 801B may include groove 809B provided in its surface. In this case, just the second sublayer 805B-2 extends into the groove whereas the first sublayer 805B-1 generally covers the surface other than the groove area. Such a structure may be formed, e.g., by providing first surface sublayer over a current collector followed by forming grooves (e.g., by scoring, etching, or the like) which removes the first surface sublayer in the grooves to form an intermediate structure. This may be followed by depositing or otherwise forming the second surface sublayer over the intermediate structure.

In FIG. 8C, current collector 801C may include surface layer 805C having first and second surface sublayers 805C-1 and 805C-2, respectively, provided over electrically conductive layer 803C. Current collector 801C may include groove 809C provided in its surface. In this case, the surface sublayers do not extend substantially into the grooves. Such a structure may be made, e.g., by providing the first and second surface sublayers over the electrically conductive layer followed by forming grooves (e.g., by scoring, etching, or the like) which removes the first and second surface sublayers. Although shown with sublayers, a similar structure can be made that has just one surface layer.

In some embodiments, the surface layer or sublayer may include a metal-oxygen compound. In some cases, a metal-oxygen compound may include a metal oxide or metal hydroxide, e.g., a transition metal oxide or a transition metal hydroxide. Unless otherwise noted, the term “transition metal” as used anywhere in the present application includes any element in groups 3 through 12 of the periodic table, including lanthanides and actinides. In some non-limiting examples, a surface layer or sublayer may include an oxide of scandium, titanium, vanadium, chromium, manganese, iron, cobalt, nickel, copper, yttrium, zinc, molybdenum, tungsten, silver, zirconium, tantalum, hafnium, tin, aluminum, indium, or niobium, or any mixture thereof. In some embodiments, a metal oxide may be an electrically conductive doped oxide, including but not limited to, indium-doped tin oxide (ITO), an aluminum-doped zinc oxide (AZO), or fluorine-doped tin oxide (FTO).

In some cases, a metal-oxygen compound may include an oxometallate, e.g., a transition oxometallate. Ordinarily, oxometallates may be considered a subclass of metal oxides. For the sake of clarity, any reference herein to “metal oxide” with respect to its use in a surface layer or sublayer excludes oxometallates unless otherwise stated or clear from the context. Oxometallates include an anionic metal oxide moiety and is associated with a cation, which may optionally be an alkali metal, an alkaline earth metal, a transition metal, or even a post transition metal. In some embodiments, a transition oxometallate may include scandium, titanium, vanadium, manganese, iron, cobalt, nickel, copper, yttrium, zirconium, niobium, molybdenum, tantalum, or tungsten, or any combination thereof, as part of the anionic metal oxide moiety. In some particularly useful embodiments, a transition oxometallate may include a chromate, tungstate, vanadate, or molybdate or any combination thereof. In some embodiments, the surface layer or surface sublayer may include, or be formed from, a transition oxometallate other than chromate.

In some embodiments, a surface layer or sublayer may include a silicon compound including or derived from a siloxane, a silane (i.e., a silane-containing compound), a silazane, or a reaction product thereof. Herein, a “silicon compound” does not include simple elemental silicon such as amorphous silicon.

In some embodiments, a surface layer or sublayer may include a silicate compound. In some cases, the silicate compound may include or be formed from silicic acid or a metal silicate, e.g., an alkali metal silicate, an alkaline earth metal silicate, and/or a transition metal silicate.

In some embodiments, a surface layer or sublayer may include a metal silicide, e.g., a transition metal silicide. In some embodiments the metal silicide may have a chemical composition characterized by MₓSi_{y}, wherein M is a transition metal, x is the combined atomic % of one or more transition metals, y is the atomic % of silicon, and the ratio of x to y is in a range of about 0.25 to about 7. The ratio of x to y may vary within the metal silicide layer. In some cases, M=Ti, V, Cr, Mn, Fe, Co, Ni, Cu, Zr, Mo, or W, or a binary or ternary combination thereof. The metal silicide may be stoichiometric or non-stoichiometric.

In some embodiments, a surface layer or sublayer may include a metal chalcogenide such as a metal sulfide, e.g., a transition metal sulfide. Some non-limiting examples of metal sulfides include sulfides of copper, zinc, iron, cobalt, nickel, vanadium, manganese, molybdenum, niobium, tantalum, or tungsten, or any mixture thereof.

### Lithium Storage Layer

In some embodiments, the lithium storage layer may be a continuous porous lithium storage layer that includes a porous material capable of reversibly incorporating lithium. In some embodiments, the lithium storage layer includes silicon, germanium, antimony, tin, or a mixture of two or more of these elements. In some embodiments, the lithium storage layer is substantially amorphous. In some embodiments, a lithium storage layer includes substantially amorphous silicon. Such substantially amorphous storage layers may include a small amount (e.g., less than 20 atomic %) of crystalline material dispersed therein. The lithium storage layer may include dopants such as hydrogen, boron, phosphorous, sulfur, fluorine, aluminum, gallium, indium, arsenic, antimony, bismuth, nitrogen, or metallic elements. In some embodiments the lithium storage layer may include porous substantially amorphous hydrogenated silicon (a-Si:H), having, e.g., a hydrogen content of from 0.1 to 20 atomic %, or alternatively higher. In some embodiments, the lithium storage layer may include methylated amorphous silicon. Note that, unless referring specifically to hydrogen content, any atomic % metric used herein for a lithium storage material or layer refers to atoms other than hydrogen.

In some embodiments, the lithium storage layer, e.g., a continuous porous lithium storage layer, may include at least 40 atomic % silicon, germanium or a combination thereof, alternatively at least 50 atomic %, alternatively at least 60 atomic %, alternatively at least 70 atomic %, alternatively, at least 80 atomic %, alternatively at least 90 atomic %. In some embodiments, a lithium storage layer, e.g., a continuous porous lithium storage layer, may include at least 40 atomic % silicon, alternatively at least 50 atomic %, alternatively at least 60 atomic %, alternatively at least 70 atomic %, alternatively, at least 80 atomic %, alternatively at least 90 atomic %, alternatively at least 95 atomic %, alternatively at least 97 atomic %. Note that in the case of prelithiated anodes as discussed below, the lithium content is excluded from this atomic % characterization.

In some embodiments, the lithium storage layer, e.g., a continuous porous lithium storage layer, includes less than 10 atomic % carbon, alternatively less than 5 atomic %, alternatively less than 2 atomic %, alternatively less than 1 atomic %, alternatively less than 0.5 atomic %. In some embodiments, a lithium storage layer, e.g., a continuous porous lithium storage layer, is substantially free (i.e., the lithium storage layer includes less than 1% by weight, alternatively less than 0.5% by weight) of carbon-based binders, graphitic carbon, graphene, graphene oxide, reduced graphene oxide, carbon black and conductive carbon. A few non-limiting examples of carbon-based binders may include organic polymers such as those based on styrene butadiene rubber, polyvinylidene fluoride, polytetrafluoroethylene, polyacrylic acid, carboxymethyl cellulose, or polyacrylonitrile.

The lithium storage layer, e.g., a continuous porous lithium storage layer, may include voids or interstices (pores), which may be random or non-uniform with respect to size, shape, and distribution. Such porosity does not result in, or result from, the formation of any recognizable lithium storage nanostructures such as nanowires, nanopillars, nanotubes, ordered nanochannels or the like. In some embodiments, the pores may be polydisperse. In some embodiments, the lithium storage layer, e.g., a continuous porous lithium storage layer, may be characterized as nanoporous. In some embodiments the lithium storage layer, e.g., a continuous porous lithium storage layer, has an average density in a range of 1.0-1.1 g/cm³, alternatively 1.1-1.2 g/cm³, alternatively 1.2-1.3 g/cm³, alternatively 1.3-1.4 g/cm³, alternatively 1.4-1.5 g/cm³, alternatively 1.5-1.6 g/cm³, alternatively 1.6-1.7 g/cm³, alternatively 1.7-1.8 g/cm³, alternatively 1.8-1.9 g/cm³, alternatively 1.9-2.0 g/cm³, alternatively 2.0-2.1 g/cm³, alternatively 2.1-2.2 g/cm³, alternatively 2.2-2.25 g/cm³, alternatively 2.25-2.29 g/cm³, or any combination of ranges thereof, and includes at least 70 atomic % silicon, 80 atomic % silicon, alternatively at least 85 atomic % silicon, alternatively at least 90 atomic % silicon, alternatively at least 95 atomic % silicon. Note that a density of less than 2.3 g/cm³ is evidence of the porous nature of a-Si containing lithium storage layers.

In some embodiments, the majority of active material (e.g., silicon, germanium or alloys thereof) of the lithium storage layer, e.g., a continuous porous lithium storage layer, has substantial lateral connectivity across portions of the current collector, such connectivity extending around random pores and interstices. Referring again to FIG. TA, in some embodiments, “substantial lateral connectivity” means that active material at one point X in the lithium storage layer 107, e.g., a continuous porous lithium storage layer, may be connected to active material at a second point X′ in the layer at a straight-line lateral distance LD that is at least as great as the average thickness T of the lithium storage layer, alternatively, a lateral distance at least 2 times as great as the thickness, alternatively, a lateral distance at least 3 times as great as the thickness. Not shown, the total path distance of material connectivity, including circumventing pores, following bridges between lithium storage layer segments, and following the topography of the current collector, may be longer than LD. In some embodiments, the lithium storage layer may be described as a matrix of interconnected silicon, germanium or alloys thereof, with random pores and interstices embedded therein. In some embodiments, the lithium storage layer may have a sponge-like form. It should be noted that a continuous porous lithium storage layer does not necessarily extend across the entire anode without any lateral breaks and may include random discontinuities or cracks and still be considered continuous. In some embodiments, such discontinuities may occur more frequently on rough current collector surfaces. In some embodiments, the lithium storage layer, e.g., a continuous porous lithium storage layer, may include adjacent columns of silicon and/or nanoparticle aggregates. In some embodiments, the lithium storage layer may include a mixture of amorphous and crystalline silicon, e.g., nano-crystalline silicon having an average grain size of less than about 100 nm, alternatively less than about 50 nm, 20 nm, 10 nm, or 5 nm. In some cases, the lithium storage layer may include up to 30 atomic % nano-crystalline silicon relative to all silicon in the lithium storage layer.

In some embodiments, the lithium storage layer, e.g., a continuous porous lithium storage layer, includes a substoichiometric oxide of silicon (SiOₓ), germanium (GeOₓ) or tin (SnOₓ) wherein the ratio of oxygen atoms to silicon, germanium or tin atoms is less than 2:1, i.e., x<2, alternatively less than 1:1, i.e., x<1. In some embodiments, x is in a range of 0.02 to 0.95, alternatively 0.02 to 0.10, alternatively 0.10 to 0.50, or alternatively 0.50 to 0.95, alternatively 0.95 to 1.25, alternatively 1.25 to 1.50, or any combination of ranges thereof.

In some embodiments, the lithium storage layer, e.g., a continuous porous lithium storage layer, includes a substoichiometric nitride of silicon (SiN_{y}), germanium (GeN_{y}) or tin (SnN_{y}) wherein the ratio of nitrogen atoms to silicon, germanium or tin atoms is less than 1.25:1, i.e., y<1.25. In some embodiments, y is in a range of 0.02 to 0.95, alternatively 0.02 to 0.10, alternatively 0.10 to 0.50, or alternatively 0.50 to 0.95, alternatively 0.95 to 1.20, or any combination of ranges thereof. Lithium storage layer having a substoichiometric nitride of silicon may also be referred to as nitrogen-doped silicon or a silicon-nitrogen alloy.

In some embodiments, the lithium storage layer, e.g., a continuous porous lithium storage layer, includes a substoichiometric oxynitride of silicon (SiOₓN_{y}), germanium (GeOₓN_{y}), or tin (SnOₓN_{y}) wherein the ratio of total oxygen and nitrogen atoms to silicon, germanium or tin atoms is less than 1:1, i.e., (x+y)<1. In some embodiments, (x+y) is in a range of 0.02 to 0.95, alternatively 0.02 to 0.10, alternatively 0.10 to 0.50, or alternatively 0.50 to 0.95, or any combination of ranges thereof.

In some embodiments, the above sub-stoichiometric oxides, nitrides or oxynitrides are provided by a CVD process, including but not limited to, a PECVD process. The oxygen and nitrogen may be provided uniformly within the lithium storage layer, or alternatively the oxygen or nitrogen content may be varied as a function of storage layer thickness.

### CVD

CVD generally involves flowing a precursor gas, a gasified liquid in terms of direct liquid injection CVD or gases and liquids into a chamber containing one or more objects, typically heated, to be coated. Chemical reactions may occur on and near the hot surfaces, resulting in the deposition of a thin film on the surface. This is accompanied by the production of chemical by-products that are exhausted out of the chamber along with unreacted precursor gases. As would be expected with the large variety of materials deposited and the wide range of applications, there are many variants of CVD that may be used to form the lithium storage layer, the surface layer or sublayer, a supplemental layer (see below) or other layers. It may be done in hot-wall reactors or cold-wall reactors, at sub-torr total pressures to above-atmospheric pressures, with and without carrier gases, and at temperatures typically ranging from 100-1600° C. in some embodiments. There are also a variety of enhanced CVD processes, which involve the use of plasmas, ions, photons, lasers, hot filaments, or combustion reactions to increase deposition rates and/or lower deposition temperatures. Various process conditions may be used to control the deposition, including but not limited to, temperature, precursor material, gas flow rate, pressure, substrate voltage bias (if applicable), and plasma energy (if applicable).

As mentioned, the lithium storage layer, e.g., a continuous porous layer of silicon or germanium or both, may be provided by plasma-enhanced chemical vapor deposition (PECVD). Relative to conventional CVD, deposition by PECVD can often be done at lower temperatures and higher rates, which can be advantageous for higher manufacturing throughput. In some embodiments, the PECVD is used to deposit a substantially amorphous silicon layer (optionally doped) over the surface layer. In some embodiments, PECVD is used to deposit a substantially amorphous silicon layer over the surface layer.

In PECVD processes, according to various implementations, a plasma may be generated in a chamber in which the substrate is disposed or upstream of the chamber and fed into the chamber. Various types of plasmas may be used including, but not limited to, capacitively-coupled plasmas, inductively-coupled plasmas, and conductive coupled plasmas. Any appropriate plasma source may be used, including DC, AC, RF, VHF, hollow cathode, combinatorial PECVD and microwave sources may be used. In some embodiments, magnetron assisted RF PECVD may be used. PECVD process conditions (temperatures, pressures, precursor gases, carrier gases, dopant gases, flow rates, energies, and the like) can vary according to the particular process and tool used, as is well known in the art. In some embodiments, the temperature at the current collector during at least a portion of the time of PECVD deposition is in a range of 20° C. to 50° C., 50° C. to 100° C., alternatively 100° C. to 200° C., alternatively 200° C. to 300° C., alternatively 300° C. to 400° C., alternatively 400° C. to 500° C., alternatively 500° C. to 600° C., or any combination of ranges thereof.

The thickness or mass per unit area of the lithium storage layer, e.g., a continuous porous lithium storage layer, depends on the lithium storage material, the desired charge/discharge capacity (generally referred to herein as “storage capacity”) and other operational and lifetime considerations. Increasing the thickness typically provides more capacity. If the lithium storage layer becomes too thick, electrical resistance may increase and the stability may decrease. In some embodiments, the anode may be characterized as having an active silicon areal density of at least 1.0 mg/cm², alternatively at least 1.5 mg/cm², alternatively at least 3 mg/cm², alternatively at least 5 mg/cm². In some embodiments, the lithium storage layer may be characterized as having an active silicon areal density in a range of 1.5-2 mg/cm², alternatively in a range of 2-3 mg/cm², alternatively in a range of 3-5 mg/cm², alternatively in a range of 5-10 mg/cm², alternatively in a range of 10-15 mg/cm², alternatively in a range of 15-20 mg/cm², or any combination of ranges thereof. “Active silicon” refers to the silicon in electrical communication with the current collector that is available for reversible lithium storage at the beginning of cell cycling, e.g., after anode “electrochemical formation” discussed later. “Areal density” refers to the geometric surface area of the electrically conductive layer over which active silicon is provided. In some embodiments, not all of the silicon content is active silicon, i.e., some may be tied up in the form of non-active silicides or may be electrically isolated from the current collector.

In some embodiments the lithium storage, e.g., a continuous porous lithium storage layer, has an average thickness of at least 1 μm, alternatively at least 2.5 μm, alternatively at least 6.5 μm. In some embodiments, the lithium storage layer, e.g., a continuous porous lithium storage layer, has an average thickness in a range of about 0.5 μm to about 50 μm. In some embodiments, the lithium storage layer, e.g., a continuous porous lithium storage layer, comprises at least 80 atomic % amorphous silicon and/or has a thickness in a range of 1-1.5 μm, alternatively 1.5-2.0 μm, alternatively 2.0-2.5 μm, alternatively 2.5-3.0 μm, alternatively 3.0-3.5 μm, alternatively 3.5-4.0 μm, alternatively 4.0-4.5 μm, alternatively 4.5-5.0 μm, alternatively 5.0-5.5 μm, alternatively 5.5-6.0 μm, alternatively 6.0-6.5 μm, alternatively 6.5-7.0 μm, alternatively 7.0-8.0 μm, alternatively 8.0-9.0 μm, alternatively 9.0-10 μm, alternatively 10-15 μm, alternatively 15-20 μm, alternatively 20-25 μm, alternatively 25-30 μm, alternatively 30-40 μm, alternatively 40-50 μm, or any combination of ranges thereof.

### Other Anode Features

The anode may optionally include various additional layers and features. The current collector may include one or more features to ensure that a reliable electrical connection can be made in the energy storage device. In some embodiments, a supplemental layer is provided over the lithium storage structure. In some embodiments, the supplemental layer acts as an artificial SEI or as a protection layer to enhance lifetime (cycle life or calendar life) or physical durability. The supplemental layer may be an oxide formed from the lithium storage material itself, e.g., silicon dioxide in the case of silicon, or some other suitable material. A supplemental layer may be deposited, for example, by ALD, MLD, CVD, PECVD, evaporation, sputtering, solution coating, ink jet or any method that is compatible with the anode. In some embodiments, the top surface of the supplemental layer may correspond to a top surface of the anode. As mentioned, the current collector grooves may induce segmentation in the lithium storage layer. In such cases, the sidewalls (or portions thereof) of the lithium storage layer segments may also be coated with beneficial supplemental layer material that is otherwise not possible without the segmented structure. ALD and MLD deposition methods may be particularly suitable to accessing lithium storage layer segment sidewalls when their spacing is very small.

A supplemental layer should be reasonably conductive to lithium ions and permit lithium ions to move into and out of the patterned lithium storage structure during charging and discharging. In some embodiments, the lithium ion conductivity of a supplemental layer is at least 10⁻⁹ S/cm, alternatively at least 10⁻⁸ S/cm, alternatively at least 10⁻⁷ S/cm, alternatively at least 10⁻⁶ S/cm. In some embodiments, the supplemental layer acts as a solid-state electrolyte.

Some non-limiting examples of materials used in a supplemental layer include metal oxides, nitrides, or oxynitrides, e.g., those containing aluminum, titanium, vanadium, zirconium, hafnium, or tin, or mixtures thereof. The metal oxide, metal nitride or metal oxynitride may include other components such as phosphorous or silicon. The supplemental layer may include a lithium-containing material such as lithium phosphorous oxynitride (LIPON), lithium phosphate, lithium aluminum oxide, (Li,La)ₓTi_{y}O_{z}, or LiₓSi_{y}Al₂O₃. In some embodiments, the supplemental layer includes a metal oxide, metal nitride, or metal oxynitride, and has an average thickness of less than about 100 nm, for example, in a range of about 0.1 to about 10 nm, or alternatively in a range of about 0.2 nm to about 5 nm. LIPON or other solid-state electrolyte materials having superior lithium transport properties may have a thickness of more than 100 nm, but may alternatively, be in a range of about 1 to about 50 nm.

In some embodiments, the lithium storage layer may be at least partially prelithiated prior to a first electrochemical cycle after battery assembly, or alternatively prior to battery assembly. That is, some lithium may be incorporated into the lithium storage layer to form a lithiated storage layer even prior to a first battery cycle. In some embodiments, the lithiated storage layer may break into smaller structures, including but not limited to platelets or islands, that remain electrochemically active and continue to reversibly store lithium. Note that “lithiated storage layer” simply means that at least some of the potential storage capacity of the lithium storage layer is filled, but not necessarily all. In some embodiments, the lithiated storage layer may include lithium in a range of T % to 5% of the theoretical lithium storage capacity of the lithium storage layer, alternatively 5% to 10%, alternatively 10% to 15%, alternatively 15% to 20%, alternatively, 20% to 30%, alternatively 30% to 40%, alternatively 40% to 50%, alternatively 50% to 60%, alternatively 60% to 70%, alternatively 70% to 80%, alternatively 80% to 90%, alternatively 90% to 100%, or any combination of ranges thereof. In some embodiments, a surface layer may capture some of the lithium, and one may need to account for such capture to achieve the desired lithium range in the lithiated storage layer.

In some embodiments prelithiation may include depositing lithium metal over the lithium storage layer, alternatively between one or more lithium storage sublayers, or both, e.g., by evaporation, e-beam or sputtering. Alternatively, prelithiation may include contacting the anode with a reductive lithium organic compound, e.g., lithium naphthalene, n-butyllithium or the like. In some embodiments, prelithiation may include incorporating lithium by electrochemical reduction of lithium ion in prelithiation solution. In some embodiments, prelithiation may include a thermal treatment to aid the diffusion of lithium into the lithium storage layer.

In some embodiments the anode may be thermally treated prior to battery assembly. In some embodiments, thermally treating the anode may improve adhesion of the various layers or electrical conductivity, e.g., by inducing migration of metal from the current collector or atoms from the optional supplemental layer into the lithium storage layer. In some embodiments, the lithium storage layer, e.g., a continuous porous lithium storage layer, includes at least 80 atomic % amorphous silicon and at least 0.05 atomic % copper, alternatively at least 0.1 atomic % copper, alternatively at least 0.2 atomic % copper, alternatively at least 0.5 atomic % copper, alternatively at least 1 atomic % copper. In some embodiments, the lithium storage layer, e.g., a continuous porous lithium storage layer, may include at least 80 atomic % amorphous silicon and also include copper in an atomic % range of 0.05-0.1%, alternatively 0.1-0.2%, alternatively 0.2-0.5%, alternatively 0.5-1%, alternatively 1-2%, alternatively 2-3%, alternatively 3-5%, alternatively 5-7%, or any contiguous combination of ranges thereof. In some embodiments, the aforementioned ranges of atomic % copper may correspond to a cross-sectional area of the lithium storage layer of at least 1 μm², which may be measured, e.g., by energy dispersive x-ray spectroscopy (EDS). In some embodiments, there is a gradient where the concentration of copper in portions of the lithium storage layer near the current collector is higher than portions further from the current collector. In some embodiments, instead of copper or in addition to copper, the lithium storage layer may include a transition metal that is from a material forming part of the surface layer. The atomic % of such transition metals may be present in the lithium storage layer in any of the atomic % ranges mentioned above with respect to copper. In some embodiments, the lithium storage layer may include more copper than other transition metals. Special thermal treatments are not always necessary to achieve migration of transition metals into the lithium storage layer.

In some embodiments, thermally treating the anode may be done in a controlled environment having a low oxygen and water (e.g., less than 10 ppm or partial pressure of less than 0.1 Torr, alternatively less than 0.01 Torr) content to prevent degradation. In some embodiments, anode thermal treatment may be carried out using an oven, infrared heating elements, contact with a hot plate or exposure to a flash lamp. The anode thermal treatment temperature and time depend on the materials of the anode. In some embodiments, anode thermal treatment includes heating the anode to a temperature of at least 50° C., optionally in a range of 50° C. to 950° C., alternatively 100° C. to 250° C., alternatively 250° C. to 350° C., alternatively 350° C. to 450° C., alternatively 450° C. to 550° C., alternatively 550° C. to 650° C., alternatively 650° C. to 750° C., alternatively 750° C. to 850° C., alternatively 850° C. to 950° C., or a combination of these ranges. In some embodiments, the thermal treatment may be applied for a time period of 0.1 to 120 minutes.

In some embodiments one or more processing steps described above may be performed using roll-to-roll methods wherein the electrically conductive layer or current collector is in the form of a rolled film, e.g., a roll of metal foil, mesh or fabric.

### Battery Features

The preceding description relates primarily to the anode/negative electrode of a lithium-ion battery (LIB). The LIB typically includes a cathode/positive electrode, an electrolyte and a separator (if not using a solid-state electrolyte). As is well known, batteries can be formed into multilayer stacks of anodes and cathodes with an intervening separator. Such assemblies may, for example, be provided into pouch cells or prismatic cells. Alternatively, anode/cathode stacks can be wound into a so-called jelly-roll and used, e.g., in cylindrical cells or wound prismatic cells. The current collector grooves and/or the segmented lithium storage layer structure may in some cases be more robust to such winding methods and structures.

### Cathode

Positive electrode (cathode) materials include, but are not limited to, lithium metal oxides or compounds (e.g., LiCoO₂, LiFePO₄, LiMnO₂, LiNiO₂, LiMn₂O₄, LiCoPO₄, LiNiₓCo_{y}Mn_{z}O₂, LiNi_{X}Co_{Y}Al_{Z}O₂, LiFe₂(SO₄)₃, or Li₂FeSiO₄), carbon fluoride, metal fluorides such as iron fluoride (FeF₃), metal oxide, sulfur, selenium and combinations thereof. Cathode active materials may operate, e.g., by intercalation, conversion, or a combination. Cathode active materials are typically provided on, or in electrical communication with, an electrically conductive cathode current collector.

### Current Separator

The current separator allows ions to flow between the anode and cathode but prevents direct electrical contact. Such separators are typically porous sheets. Non-aqueous lithium-ion separators are single layer or multilayer polymer sheets, typically made of polyolefins, especially for small batteries. Most commonly, these are based on polyethylene or polypropylene, but polyethylene terephthalate (PET) and polyvinylidene fluoride (PVdF) can also be used. For example, a separator can have>30% porosity, low ionic resistivity, a thickness of ˜10 to 50 μm and high bulk puncture strengths. Separators may alternatively include glass materials, ceramic materials, a ceramic material embedded in a polymer, a polymer coated with a ceramic, or some other composite or multilayer structure, e.g., to provide higher mechanical and thermal stability.

### Electrolyte

The electrolyte in lithium-ion cells may be a liquid, a solid, or a gel. A typical liquid electrolyte includes one or more solvents and one or more salts, at least one of which includes lithium. During the first few charge cycles (sometimes referred to as formation cycles), the organic solvent and/or the electrolyte may partially decompose on the negative electrode surface to form an SEI (Solid-Electrolyte-Interphase) layer. The SEI is generally electrically insulating but ionically conductive, thereby allowing lithium ions to pass through. The SEI may lessen decomposition of the electrolyte in the later charging cycles. In some cases, a lithium storage layer having a segmented structure may provide improved (e.g., more uniform) SEI formation and/or electrolyte contact with the anode (wetting).

Some non-limiting examples of non-aqueous solvents suitable for some lithium ion cells include the following: cyclic carbonates (e.g., ethylene carbonate (EC), fluoroethylene carbonate (FEC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC, also commonly abbreviated EMC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

Non-aqueous liquid solvents can be employed in combination. Examples of these combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In some embodiments, a cyclic carbonate may be combined with a linear ester. Moreover, a cyclic carbonate may be combined with a lactone and a linear ester. In some embodiments, the weight ratio, or alternatively the volume ratio, of a cyclic carbonate to a linear ester is in a range of 1:9 to 10:1, alternatively 2:8 to 7:3.

A salt for liquid electrolytes may include one or more of the following non-limiting examples: LiPF₆, LiBF₄, LiClO₄ LiAsF₆, LiN(CF₃SO₂)₂(“LiTFSI”), LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃ (iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), LiFSI (lithium bis(fluorosulfonyl)imide), LiTDI (lithium 4,5-dicyano-2-(trifluoromethyl)imidazole), and combinations thereof.

In some embodiments, the total concentration of a lithium salt in a liquid non-aqueous solvent (or combination of solvents) is at least 0.3 M, alternatively at least 0.7 M. The upper concentration limit may be driven by a solubility limit and operational temperature range. In some embodiments, the concentration of salt is no greater than about 2.5 M, alternatively no more than about 1.5 M. In some embodiments, the electrolyte may include a saturated solution of a lithium salt and excess solid lithium salt.

In some embodiments, the battery electrolyte includes a non-aqueous ionic liquid and a lithium salt. Additives may be included in the electrolyte to serve various functions such as to stabilize the battery. For example, additives such as polymerizable compounds having an unsaturated double bond may be added to stabilize or modify the SEI. Certain amines or borate compounds may act as cathode protection agents. Lewis acids can be added to stabilize fluorine-containing anions such as PF₆. Safety protection agents include those to protect overcharge, e.g., anisoles, or act as fire retardants, e.g., alkyl phosphates.

### Solid-State and Gel Electrolytes

A solid-state electrolyte (SSE) includes a source of mobile lithium ions that diffuse between the anode and the cathode (to the anode during charging and away from the anode during discharging). The three main families of SSE are solid polymer electrolytes (SPEs), solid inorganic electrolytes (SIEs), and hybrid SSE which uses both SPE and SIE materials. In some cases, the source of lithium ion may include a lithium salt, which may be in the form of a small molecule (e.g., LiTSFI, LiPF₆ or some any other lithium salt described elsewhere) suspended or dissolved in a SSE matrix. In some cases, a SPE material may include an anionic functional group that may act as the lithium salt counterion. The SSE may optionally include plasticizers, rheology control agents, or even a small amount of organic solvent(s).

A few non-limiting examples of polymeric materials that may be used in the SSE composition include poly(ethylene oxide) (PEO), poly(acrylonitrile) (PAN), poly(methyl methacrylate) (PMMA), poly(vinyl alcohol) (PVA), poly(trimethylene carbonate), diester-based polymer, PVdF-based polymers, polycaprolactone, and their derivatives or copolymers, which may be used alone or in combination. The polymer of the SSE may in some cases be cross-linked or branched. The polymer may be a block copolymer. A polymer SSE may be fully amorphous or include some crystallinity. The polymer may include anionic functional groups.

A few non-limiting classes of SIE material that may be used in the SSE composition include b-aluminas, NASICONs, perovskites, antiperovskites, garnets, complex hydrides, and solid sulfides.

In some embodiments, under battery operating conditions, the SSE may have a lithium-ion conductivity in a range of 0.0001 mS/cm to 0.001 mS/cm, alternatively in a range of 0.001 mS/cm to 0.01 mS/cm, alternatively in a range of 0.01 mS/cm to 0.1 mS/cm, alternatively in a range of 0.1 mS/cm to 1.0 mS/cm, alternatively higher than 1 mS/cm.

Gel electrolytes may in some cases be similar to solid polymer electrolytes described above, but that generally employ lower viscosity materials or mixtures, e.g., lower molecular weight polymers, plasticizers, or the like. There is no standard delineation of viscosities between what constitutes a solid-state electrolyte, a gel electrolyte, or a liquid electrolyte. Herein, gel electrolytes may be those having a viscosity in a range of about 1 Pa-sec to 1000 Pa-sec, whereas liquid electrolytes may be lower than this range and solid-state electrolytes (if even measurable) may be higher than this range. Some solid-state electrolytes, particularly SIEs and higher molecular weight solid polymers, are not readily characterized by a viscosity metric. Note that a polymer separator made from a free-standing film that may have gel-like properties in the presence of liquid electrolyte is not considered herein as a gel electrolyte, but as a separator.

In some cases, a solid-state electrolyte may be used without the separator(s) because it may serve as the separator itself so long as it is electrically insulating, ionically conductive, electrochemically stable, and mechanically stable. If the SSE is more gel-like, then the cell may still benefit from a separator. In some cases, multiple solid-state or gel electrolytes may be used, e.g., one electrolyte material associated with the anode (anolyte), another electrolyte material associated with the cathode (catholyte), and/or an electrolyte material disposed in between and associated with both the anode and cathode. In some embodiments, an electrolyte may be initially in a liquid state but may be in situ polymerized to a gel or solid state.

### Electrochemical Formation and Cycling

In some embodiments, the original, non-cycled anode may undergo structural or chemical changes during electrochemical charging/discharging, for example, from normal battery usage or from an earlier “electrochemical formation step”. As is known in the art, an electrochemical formation step is commonly used to form an initial SEI layer and involves relatively gentle conditions of low current and limited voltages. The modified anode prepared in part from such electrochemical charging/discharging cycles may still have excellent performance properties, despite such structural and/or chemical changes relative to the original, non-cycled anode. In some embodiments, the lithium storage layer of the cycled anode may no longer appear as a continuous layer, and instead, appear as separated pillars or islands, generally with a height-to-width aspect ratio of less than 2. While not being bound by theory, in the case of amorphous silicon, it may be that small amounts delaminate upon cycling at high stress areas. Alternatively, or in addition, it may be that structural changes upon lithiation and delithiation are non-symmetrical resulting in such islands or pillars.

In some embodiments, electrochemical cycling conditions may be set to utilize only a portion of the theoretical gravimetric storage capacity of silicon (3600 mAh/g). In some embodiments, electrochemical charging/discharging cycles may be set to utilize 400-600 mAh/g, alternatively 600-800 mAh/g, alternatively 800-1000 mAh/g, alternatively 1000-1200 mAh/g, alternatively 1200-1400 mAh/g, alternatively 1400-1600 mAh/g, alternatively 1600-1800 mAh/g, alternatively 1800-2000 mAh/g, alternatively 2000-2200 mAh/g, alternatively 2200-2400 mAh/g, alternatively 2400-2600 mAh/g, alternatively 2600-2800 mAh/g, alternatively 2800-3000 mAh/g, alternatively 3000-3200 mAh/g, alternatively 3200-3400 mAh/g, or any combination of ranges thereof.

### EXAMPLES

### Test PECVD

An Oxford Plasmalabs System 100 PECVD tool was used to deposit silicon onto various current collectors. Depositions were conducted at about 300° C. at an RF power in a range of about 300 W. The deposition gas was a mixture of silane and argon in a gas flow ratio of about 1 to 11, respectively. Unless otherwise noted, the deposition time was 38 minutes which provided about a 7 μm thick, porous amorphous silicon layer on the current collector.

### Test Current Collectors

CC-1. A 16 μm copper foil having a surface roughness Sa=514 nm was provided (“copper starting foil”). The surface did not include nanopillar features but included those that may be described as nodules or broad roughening features. A silicon-compound surface layer was formed by immersing the foil in a bath of a silane coupling agent (3-glycidoxyprpyl triethoxysilane) in a water/ethanol solvent mixture for 30 seconds. The foil was hung to dry and then treated in a 140° C. oven for 30 minutes. No grooves were provided in CC-1. The silane-compound surface layer is often not as effective some other surface layers, e.g., some metal oxides or oxometallates have been found to perform better under some conditions. The silane-compound surface layer was purposefully chosen to provide marginal performance to more clearly determine the impact of grooves.

CC-2. The copper starting foil was first treated to form grooves by running a 600-grit sandpaper with light pressure over the foil surface approximately 4 times in a first direction and 4 times in a second direction, substantially orthogonal to the first (about 90°±10°). After forming the grooves, a silicon-compound surface layer was formed using the same method as described in CC-1.

CC-3. CC-3 was made like CC-2 except 800-grit sandpaper (i.e., finer grit than 600-grit sandpaper) was used.

CC-4. CC-4 was made like CC-3, except that running the 800-grit sandpaper over the surface was performed about 15 times in each direction.

Some surface properties of the current collectors were determined by white light interferometry using a Bruker Contour GT 3D optical microscope, typically at 10× magnification across an area of about 600×450 μm. The number of grooves in each sanding direction was estimated from these images by visual assessment and used to calculate an average line spacing.

Half cells were constructed using a 0.80 cm diameter punch of each anode. Lithium metal served as the counter electrode which was separated from the test anode using Celgard™ separators. The standard electrolyte solution included: a) 88 wt. % of 1.2 M LiPF₆ in 3:7 EC:EMC (weight ratio); b) 10 wt. % FEC; and c) 2 wt. % VC. Anodes first underwent an electrochemical formation step. The electrochemical formation step is used to form an initial SEI layer. Relatively gentle conditions of low current and/or limited voltages may be used to ensure that the anode is not overly stressed. In the present examples, electrochemical formation included several cycles over a wide voltage range (about 0.01 to 1.2V) at C-rates ranging from C/20 to C/10. The total or maximum storage capacity (mAh/cm²) of the anode was determined from the electrochemical formation step data. The anodes had an average initial storage capacity of about 5 mAh/cm² but there were some formation losses as shown in the table below. Formation losses were calculated by dividing the change in active areal charge capacity (initial first charge capacity minus last formation discharge capacity) by the initial areal first charge capacity.

Two different cycling protocols were tested. In the first set of tests, an aggressive rapid charging protocol was applied (“Rapid Charge”). This rapid protocol included 3.2 C charge (for 15 min) and C/3 discharge to roughly a 15% state of charge. While silicon has a theoretical gravimetric storage capacity of about 3600 mAh/g when used in lithium-ion batteries, it has been found that cycle life may improve if only a portion of the full capacity is used. In this rapid charge test, the used capacity (“rated capacity”) corresponded to 1200 mAh/g. Note that the test using 3.2 C charging for 15 minutes is based on a test commonly used in the automotive industry and is considered very aggressive with respect to charging. The 15-minute period corresponds to charging to a maximum 80% of the anode's rated capacity of 1.3 mA/cm². In the second set of tests, an aggressive rated capacity protocol was applied (“High Rating”). Here the charge and discharge rates were both relatively mild at C/4 each, but the rated capacity was very high at 2500 mAh/g resulting in an anode capacity of about 2.9 mA/cm². Such anodes are expected to expand and contract significantly more than the anodes of the rapid charge protocol.

Table 1 summarizes some current collector properties and cycling performance of the test anodes under the two cycling protocols. Sa and Sq correspond to the average surface roughness and the root mean square surface roughness, respectively, of the current collector surface prior to silicon deposition. Cycle life corresponds to the number of cycles it takes for an anode to fall below 80% of the initial storage capacity is commonly referred to as its “80% SoH cycle life” where “SoH” refers to “state-of-health”.

TABLE 1

| | | | | Ave. groove | | Cycle life | Cycle life |
|---|---|---|---|---|---|---|---|
| | Current | Sa | Sq | spacing | Formation | Rapid | High |
| Anode | collector | (nm) | (nm) | (μm) | losses (%) | Charge | Rating |
| Comparative A | CC-1 | 514 | 650 | n/a | 31 | fail | 22 |
| Example A | CC-2 | 530 | 678 | 35 | 23 | 153 | 25 |
| Example B | CC-3 | 499 | 662 | 40 | 13 | 135 | 32 |
| Example C | CC-4 | 1438 | 1799 | 25 | 25 | 180 | 66 |

Referring to Table 1, Comparative Anode A had the highest electrochemical formation losses and shortest cycle life in the High Rating protocol test. Further, it failed to even reach the expected capacity in the Rapid Charge test. The Example anodes all performed better than Comparative A with respect to formation loss and cycle life. Of note is that current collectors CC-2 and CC-3 had about the same Sa and Sq roughness metrics as the CC-1, but the presence of the grooves provided reduced formation loss and increased cycle life. Thus, the advantages of the grooves are not tied solely to surface roughness. However, it is also noted that the best performing anode used CC-4 which had substantially higher surface roughness Sa and Sq. It also had lower average groove spacing. In some cases, the combination of increased average surface roughness and grooves can provide improved device performance. In some embodiments, the current collector may have Sa in a range of 450-600 nm and an average groove spacing in a range of 30-50 μm. In some embodiments, the current collector may have Sa>600 nm (e.g., in a range of 600-1500 nm) and an average groove spacing in a range of 15-30 μm. As mentioned, these tests were not designed to provide the highest cycle life, but to show the effect of adding grooves to the current collector. Higher performance may be achieved, e.g., with metal oxide- or oxometallate-containing surface layers.

Still further embodiments herein include the following enumerated embodiments.
1. An anode for an energy storage device, the anode including:
a) a current collector including an electrically conductive layer and a surface layer disposed over the electrically conductive layer, wherein a current collector surface is characterized by a plurality of grooves; and
b) a lithium storage layer overlaying the surface layer, wherein the lithium storage layer is characterized by a first average thickness and includes at least 40 atomic % silicon, germanium, or a combination thereof,
wherein, in at least one lateral dimension, the grooves are spaced apart by an average spacing distance that is 0.4 to 50 times the first average thickness.
2. The anode of embodiment 1, wherein the plurality of grooves includes a first set of substantially parallel grooves.
3. The anode of embodiment 2, wherein the plurality of grooves further includes a second set of substantially parallel grooves provided at an angle to the first set of substantially parallel grooves.
4. The anode of embodiment 3, wherein the second set of substantially parallel grooves intersect the first set of substantially parallel grooves at an average angle in a range of 45° to 135°.
5. The anode of embodiment 4, wherein the average angle is in a range of 60° to 120°.
6. The anode according to any of embodiments 1-5, wherein the grooves have an average depth in a range of about 100 nm up to 0.25 times the first average thickness.
7. The anode according to any of embodiments 1-6, wherein the plurality of grooves has an average groove width that is less than 10 times an average groove depth.
8. The anode according to any of embodiments 1-7, wherein the electrically conductive layer includes roughening features.
9. The anode of embodiment 8, wherein the roughening features include nanopillar features.
10. The anode according to any of embodiments 1-9, wherein the surface layer includes a metal-oxygen compound.
11. The anode according to any of embodiments 1-10, wherein the surface layer includes a metal oxide.
12. The anode according to any of embodiments 1-11, wherein the surface layer includes an oxometallate.
13. The anode according to any of embodiments 1-12, wherein the surface layer includes a metal silicide.
14. The anode according to any of embodiments 10-13, wherein the surface layer includes a transition metal.
15. The anode according to any of embodiments 1-14, wherein the surface layer includes a silicate compound.
16. The anode according to any of embodiments 1-15, wherein the surface layer includes a silicon compound formed from a silicon compound agent.
17. The anode according to any of embodiments 1-16, wherein the surface layer includes two or more surface sublayers each having a chemical composition different from an adjacent surface sublayer.
18. The anode according to any of embodiments 1-17, further including a metal sublayer interposed between the electrically conductive layer and the surface layer, wherein the metal sublayer includes a zero-valent metal.
19. The anode of embodiment 18, wherein the metal sublayer includes zinc, nickel, or zinc-nickel alloy.
20. The anode of embodiment 19, wherein the surface layer includes a transition oxometallate.
21. The anode according to any of embodiments 1-20, wherein the surface layer is disposed both within the grooves and on areas outside of the grooves.
22. The anode of embodiment 21, wherein the surface layer includes a second surface layer composition within the grooves that is different from a first surface layer composition outside of the grooves.
23. The anode of embodiment 1-20, wherein a majority of a surface area occupied by the grooves does not include the surface layer.
24. The anode according to any of embodiments 1-23, wherein the average spacing of the grooves is in a range of 15-80 μm.
25. The anode according to any of embodiments 1-23, wherein the average spacing of the grooves is in a range of 20-50 μm.
26. The anode according to any of embodiments 1-25, wherein the current collector is characterized by a surface roughness Rₐ≥250 nm.
27. The anode according to any of embodiments 1-25, wherein the current collector is characterized by a surface roughness Rₐ≥550 nm.
28. The anode according to any of embodiments 1-25, wherein the current collector is characterized by a surface roughness Sa in a range of 450-600 nm.
29. The anode according to any of embodiments 1-25, wherein the current collector is characterized by a surface roughness Sa in a range of 600-1500 nm.
30. The anode according to any of embodiments 1-29, wherein the electrically conductive layer includes copper or a copper alloy.
31. The anode according to any of embodiments 1-30, wherein the electrically conductive layer or current collector is characterized by a tensile strength of at least 500 MPa.
32. The anode according to any of embodiments 1-31, wherein the electrically conductive layer or current collector is characterized by a tensile strength of greater than
600 Mpa.
33. The anode according to any of embodiments 1-32, wherein the electrically conductive layer or current collector is characterized by a tensile strength of at least 700 Mpa.
34. The anode according to any of embodiments 1-33, wherein the electrically conductive layer includes a metal foil.
35. The anode according to any of embodiments 1-34, wherein the electrically conductive layer has a multilayer structure including an outer electrically conductive sublayer proximate the lithium storage layer or surface layer, and an inner electrically conducive sublayer distal the lithium storage layer or surface layer, wherein the outer electrically conductive sublayer includes a softer or more malleable electrically conductive material than the inner electrically conductive sublayer.
36. The anode according to any of embodiments 1-35, wherein the lithium storage layer is substantially free of high aspect ratio lithium storage nanostructures.
37. The anode according to any of embodiments 1-36, wherein the lithium storage layer includes a continuous porous lithium storage layer.
38. The anode according to any of embodiments 1-37, wherein the lithium storage layer includes at least 80 atomic % of amorphous silicon.
39. The anode of embodiment 38, wherein the density of the lithium storage layer is in a range of 1.1 to 2.29 g/cm³.
40. The anode according to any of embodiments 1-37, wherein the lithium storage layer includes up to 30% of nano-crystalline silicon.
41. The anode according to any of embodiments 1-40, wherein the lithium storage layer includes columns of silicon nanoparticle aggregates.
42. The anode according to any of embodiments 1-41, wherein the lithium storage layer has an average thickness of at least 7 μm.
43. The anode according to any of embodiments 1-42, wherein the lithium storage layer includes at least 80 atomic % amorphous silicon and is characterized as having less than 0.5% by weight of carbon-based binders.
44. The anode of embodiment 43, wherein the lithium storage layer is formed by PVD or a CVD process.
45. The anode according to any of embodiments 1-44, wherein the lithium storage layer includes a plurality of lithium storage layer segments defined in part by discontinuities in the lithium storage layer in positions corresponding to the grooves.
46. The anode according to any of embodiments 1-45, wherein the grooves are formed solely in the surface layer.
47. The anode according to any of embodiments 1-45, wherein the electrically conductive layer includes a plurality of conductive layer grooves.
48. The anode of embodiment 47, wherein the surface layer at least partially conforms to the underlying electrically conductive layer.
49. The anode according to any of embodiments 1-48, wherein the energy storage device is a lithium-ion battery.
50. A lithium-ion battery including the anode according to any of embodiments 1-48, an electrolyte, and a cathode.
51. A method of making a current collector for use in a silicon-containing anode, the method including:
i) forming a plurality of grooves in an electrically conductive layer; and
ii) forming a surface layer over the electrically conductive layer.
52. The method of embodiment 51, wherein step (ii) is performed after step (i) such that the surface layer is formed both within the grooves and on areas outside of the grooves.
53. The method of embodiment 51, wherein step (i) is performed after step (ii), and wherein forming the plurality of grooves removes surface layer material in areas corresponding to the grooves.
54. The method of embodiment 53, wherein the surface layer corresponds to a first surface sublayer, the method further including forming a second surface sublayer over the electrically conductive substrate such that the second surface sublayer is formed within the plurality of grooves and over the first surface sublayer in areas outside of the grooves.
55. The method according to any of embodiments 51-54, wherein the electrically conductive layer has a multilayer structure including an outer electrically conductive sublayer proximate the lithium storage layer or surface layer, and an inner electrically conducive sublayer distal from the lithium storage layer or surface layer, wherein the outer electrically conductive sublayer includes an electrically conductive material that, relative to the inner electrically conductive sublayer, is softer, is more malleable, or is characterized by a faster etch rate when subjected to an etch or ablation process.
56. The method according to any of embodiments 51-55, wherein forming the plurality of grooves includes physical removal by a scoring tool.
57. The method according to any of embodiments 51-55, wherein forming the plurality of grooves includes chemical etching.
58. The method according to any of embodiments 51-55, wherein forming the plurality of grooves includes laser ablation.
59. The method according to any of embodiments 51, 52 or 55, wherein forming the plurality of grooves includes embossing.
60. The method according to any of embodiments 51-59, further including forming surface roughening features on the electrically conductive layer prior to forming the surface layer.
61. The method according to any of embodiments 51-60, wherein the electrically conductive layer includes copper.
62. The anode according to any of embodiments 51-61, wherein the surface layer includes a metal oxide.
63. The anode according to any of embodiments 51-62, wherein the surface layer includes an oxometallate.
64. The anode according to any of embodiments 51-63, wherein the surface layer includes a silicate compound.
65. The anode according to any of embodiments 62-64, wherein the surface layer further includes a transition metal.
66. The anode according to any of embodiments 51-65, wherein the surface layer includes a silicon compound formed from a silicon compound agent.
67. A method of making a current collector for use in a silicon-containing anode, the method including:
forming a surface layer over an electrically conductive layer; and forming a plurality of grooves in the surface layer.
68. The method of embodiment 67, wherein forming the plurality of grooves includes physical removal by a scoring tool.
69. The method of embodiment 67, wherein forming the plurality of grooves includes chemical etching.
70. The method of embodiment 67, wherein forming the plurality of grooves includes laser ablation.
71. The method of embodiment 67, wherein forming the plurality of grooves includes embossing.
72. The method according to any of embodiments 62-71, further including forming surface roughening features on the electrically conductive layer prior to forming the surface layer.
73. The method according to any of embodiments 62-72, wherein the electrically conductive layer includes copper.
74. The anode according to any of embodiments 62-73, wherein the surface layer includes a metal oxide.
75. The anode according to any of embodiments 62-74, wherein the surface layer includes an oxometallate.
76. The anode according to any of embodiments 62-75, wherein the surface layer includes a silicate compound.
77. The anode according to any of embodiments 74-76, wherein the surface layer further includes a transition metal.
78. The anode according to any of embodiments 62-77, wherein the surface layer includes a silicon compound formed from a silicon compound agent.
79. A method of making an anode including:
providing a current collector made by a method according to any of embodiments 51-78; and
forming, by a PVD process or by chemical vapor deposition using a silicon precursor gas, a lithium storage layer disposed over the current collector.
80. The method of embodiment 79, wherein the forming is by chemical vapor deposition including a PECVD process.
81. The method of embodiment 80, wherein the PECVD process includes forming a capacitively-coupled plasma or an inductively-coupled plasma.
82. The method of embodiment 80, wherein the PECVD process includes a DC plasma source, an AC plasma source, an RF plasma source, a VHF plasma source, or a microwave plasma source.
83. The method of embodiment 80, wherein the PECVD process includes magnetron-assisted RF PECVD.
84. The method of embodiment 80, wherein the PECVD process includes expanding thermal plasma chemical vapor deposition.
85. The method of embodiment 80, wherein the PECVD process includes hollow cathode PECVD.
86. The method according to any of embodiments 79-85, wherein the lithium storage layer includes at least 40 atomic % silicon, germanium, or a combination thereof.
87. The method according to any of embodiments 79-86, wherein the lithium storage layer includes less than 10 atomic % carbon.
88. The method according to any of embodiments 79-87, wherein the lithium storage layer is substantially free of lithium storage nanostructures.
89. The method according to any of embodiments 79-88, wherein the lithium storage layer is a continuous porous lithium storage layer.
90. The method according to any of embodiments 79-89, wherein the lithium storage layer includes a sub-stoichiometric nitride of silicon.
91. The method according to any of embodiments 79-90, wherein the lithium storage layer includes a sub-stoichiometric oxide of silicon.
92. The method according to any of embodiments 79-91, wherein the lithium storage layer includes at least 80 atomic % of amorphous silicon.
93. The method of embodiment 92, wherein the density of the lithium storage layer is in a range of 1.1 to 2.25 g/cm³. 94. The method according to any of embodiments 79-91, wherein the lithium storage layer includes up to 30% of nano-crystalline silicon.
95. The method according to any of embodiments 79-94, wherein the lithium storage layer includes columns of silicon nanoparticle aggregates.
96. The method according to any of embodiments 79-95, wherein the lithium storage layer has an average thickness of at least 7 μm.
97. The method according to any of embodiments 79-96, wherein the silicon precursor gas is silane.
98. The method according to any of embodiments 79-97, further including doping the lithium storage layer with boron, phosphorous, sulfur, fluorine, aluminum, gallium, indium, arsenic, antimony, or bismuth, or a combination thereof.
99. The anode according to any of embodiments 1-49, wherein at least some of the grooves extend substantially in straight lines.
100. The anode according to any of embodiments 1-49 or 99, wherein at least some of the grooves form one or more non-random geometric patterns or shapes.
101. The anode according to any of embodiments 1-49, 99, or 100, wherein at least some of the grooves form a random shape or pattern.
102. The anode according to any of embodiments 1-49 or 99-101, wherein at least some of the grooves extend in curved lines.

Although the present anodes have been discussed with reference to batteries, in some embodiments the present anodes may be used in hybrid lithium-ion capacitor devices.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the anode” includes reference to one or more anodes and equivalents thereof known to those skilled in the art, and so forth. The invention has now been described in detail for the purposes of clarity and understanding. However, it will be appreciated that certain changes and modifications may be practiced within the scope of the appended claims.

The term “about” denotes an approximate value or range, allowing for a reasonable degree of flexibility and tolerance, unless context dictates otherwise. It encompasses minor variations that may arise due to manufacturing processes, measurement techniques, experimental error, or other factors, without significantly affecting the functionality or purpose of the embodiments of the invention. The scope of “about” typically includes a margin of error within ±5% or ±10% of the disclosed value or range. The use of “about” does not imply interchangeability of values or ranges, and the specific magnitude of flexibility may vary based on the context and understanding of those skilled in the field.

The term “substantially” in this patent application signifies a significant or noteworthy degree of similarity, adherence, or approximation, unless context dictates otherwise. It indicates that a particular characteristic, feature, or condition of the embodiments of the invention is largely in accordance with the stated description, while allowing for minor deviations that do not detract from the overall function or purpose. “Substantially” may mean that the particular characteristic, feature, or condition is present for at least 90%, 95%, or 99% of the time or over the scope (e.g., length) of the embodiment. For example, a “substantially straight” object may mean that at least 90%, 95%, or 99% of the object is straight. “Substantially” acknowledges that practical limitations, manufacturing processes, or variations inherent to the technology may result in slight deviations. The precise extent of what constitutes “substantially” may depend on the specific context and the understanding of those skilled in the relevant field.

All publications, patents, and patent applications cited herein are hereby incorporated by reference in their entirety for all purposes. None is admitted to be prior art.

1. An anode for an energy storage device, the anode comprising:
a) a current collector comprising an electrically conductive layer and a surface layer disposed over the electrically conductive layer, wherein a current collector surface is characterized by a plurality of grooves; and
b) a lithium storage layer overlaying the current collector surface both within the grooves and outside the grooves, wherein the lithium storage layer is characterized by a first average thickness and comprises at least 40 atomic % silicon, germanium, or a combination thereof,
wherein, in at least one lateral dimension, the grooves are spaced apart by an average spacing distance that is 0.4 to 50 times the first average thickness.

2. The anode of claim 1, wherein the plurality of grooves comprises a first set of substantially parallel grooves.

3. The anode of claim 2, wherein the plurality of grooves further comprises a second set of substantially parallel grooves provided at an angle to the first set of substantially parallel grooves.

4-5. (canceled)

6. The anode of claim 1, wherein the grooves have an average depth in a range of about 100 nm up to 0.25 times the first average thickness.

7. The anode of claim 1, wherein the plurality of grooves has an average groove width that is less than 10 times an average groove depth.

8. The anode of claim 1, wherein the electrically conductive layer comprises roughening features, wherein the roughening features comprise nanopillar features.

9. (canceled)

10. The anode of claim 1, wherein the surface layer comprises a metal-oxygen compound, a metal silicide, or a silicate compound.

11-13. (canceled)

14. The anode of claim 10, wherein the surface layer comprises a transition metal.

15-16. (canceled)

17. The anode of claim 1, wherein the surface layer comprises two or more surface sublayers each having a chemical composition different from any adjacent surface sublayer.

18-20. (canceled)

21. The anode of claim 1, wherein the surface layer is disposed both within grooves and on areas outside of the grooves.

22. The anode of claim 21, wherein the surface layer comprises a second surface layer composition within the grooves that is different from a first surface layer composition outside of the grooves.

23. The anode of claim 1, wherein a majority of a surface area occupied by the grooves does not include the surface layer.

24. The anode of claim 1, wherein the average spacing of the grooves is in a range of 15-80 μm.

25-29. (canceled)

30. The anode of claim 1, wherein the electrically conductive layer comprises copper or a copper alloy.

31-34. (canceled)

35. The anode of claim 1, wherein the electrically conductive layer has a multilayer structure comprising an outer electrically conductive sublayer proximate the lithium storage layer or surface layer, and an inner electrically conductive sublayer distal the lithium storage layer or surface layer, wherein the outer electrically conductive sublayer comprises a softer or more malleable electrically conductive material than the inner electrically conductive sublayer.

36-37. (canceled)

38. The anode of claim 1, wherein the lithium storage layer comprises at least 80 atomic % of amorphous silicon.

39-44. (canceled)

45. The anode of claim 1, wherein the lithium storage layer comprises a plurality of lithium storage layer segments defined in part by discontinuities in the lithium storage layer in positions corresponding to the grooves.

46. The anode of claim 1, wherein the grooves are formed solely in the surface layer.

47. The anode of claim 1, wherein the electrically conductive layer comprises a plurality of conductive layer grooves.

48. The anode of claim 47, wherein the surface layer at least partially conforms to the underlying electrically conductive layer.

49-53. (canceled)

54. A lithium-ion battery comprising:
the anode of claim 1, an electrolyte, and a cathode.

55. The anode of claim 1, wherein the lithium storage layer comprises a sub-stoichiometric nitride of silicon.
